(19) United States
(12) Patent Application Publication
(10) Pub. No.: US 2011/0075724 A1
(43) Pub. Date: Mar. 31, 2011

(54) ENCODING PARAMETERS WITH UNIT SUM

(75) Inventors: YURIY REZNIK, SEATTLE, WA (US); CHONG U. LEE, SAN DIEGO, CA (US); JOHN H. HONG, SAN DIEGO, CA (US)

(73) Assignee: QUALCOMM INCORPORATED, San Diego, CA (US)

(21) Appl. No.: 12/887,876

(22) Filed: Sep. 22, 2010

Related U.S. Application Data
(60) Provisional application No. 61/246,861, filed on Sep. 29, 2009.

(51) Int. Cl. H04B 1/66

(52) U.S. Cl. 375/240.01; 375/E07.026

(57) ABSTRACT

In general, techniques are described for encoding parameters with unit sum. In one example, an apparatus comprising a control unit implements these parameter encoding techniques. The control unit determines parameters that sum to a constant or unit sum. The control unit includes a parameter coding unit that segments a space that contains the plurality of parameters into a set of portions. The parameter coding unit assigns a different one of a plurality of codewords to each of the portions, selects one of the set of portions that contains a point defined by the plurality of parameters, and codes the plurality of parameters using one of the plurality of codewords assigned to the selected one of the plurality of portions. Rather than code only a subset of these parameters, the parameter coding unit codes all of the parameters with the result of potentially reducing quantization error.

### CLAIM OF PRIORITY UNDER 35 U.S.C. §119

The present application for patent claims priority to Provisional Application No. 61/246,861 entitled “Encoding Parameters With Unit Sum” filed Sep. 29, 2009, and assigned to the assignee hereof and hereby expressly incorporated by reference herein.

### TECHNICAL FIELD

The disclosure relates to transformation of data and, more particularly, to transforming parameter data using codes.

### BACKGROUND

Parameters generally comprise any data that controls reproduction of content data, such as video, image, audio or speech data. Parameters may be used in a variety of applications to facilitate reproduction of content data. Often, parameters may have a unit sum or, in other words, sum to one. For example, parameters used in compressing video, image, audio or speech data often represent probabilities of an occurrence of a symbol, or weights to be attributed to a value, where such probabilities or weights naturally sum to one. As another example, parameters used to control reproduction of color often sum to one as well. As still another example, parameters that represent filter or transform coefficients also sum to one.

Parameters having unit sum are often coded to reduce overhead with respect to a particular application. To illustrate, in audio compression, filter coefficients, which are one example of a set of parameters, may be periodically sent from an audio encoder to an audio decoder. To reduce compression overhead, e.g., transmittal of data not related to the content data, such as the filter coefficients, the video encoder may encode the parameters using Huffman or Tunstall codes to reduce a number of bits used to represent the parameters. Parameters, in other instances, may be encoded to facilitate reproduction of content data. To illustrate this aspect of parameter encoding, a display driver device may use a sequence of digits in a code representing parameters to facilitate control of light sources responsible for reproducing color of a particular pixel of a video frame.

To encode parameters with unit sum, often the encoder only codes a subset of the parameters. The encoder may eliminate one or more of the parameters and encode the remaining subset, as the eliminated parameters may be determined by summing the values of those parameters not eliminated and subtracting this sum from one. The decoder may receive the subset of encoded parameters, decode the encoded parameters, sum the decoded parameters and subtract the sum from one to determine or otherwise recover the eliminated one of the parameters. As only a subset of parameters having unit sum may be encoded rather than each and every one of the parameters, an encoder such as a video encoder may reduce compression overhead or otherwise facilitate reproduction of content data.

### SUMMARY

In general, this disclosure is directed to techniques for encoding parameters having a unit sum. A set of parameters have a unit sum when the sum of the set of parameters equals one. Rather than eliminate one of the parameters (as this eliminated parameters may be determined by subtracting from one the sum of the other parameters) and encode the remaining subset of parameters resulting from the elimination of the one of the parameters, the techniques set forth in this disclosure encode each and every one of the set of parameters. By encoding each and every one of the parameters, the techniques may improve quantization and subsequent encoding of these parameters by reducing quantization error.

In one aspect, a method comprises segmenting, with an apparatus, a space that contains a plurality of parameters into a set of portions, wherein the plurality of parameters sum to a constant sum, assigning, with the apparatus, a different one of a plurality of codewords to each of the portions, selecting, with the apparatus, one of the set of portions that contains a point defined by the plurality of parameters, and coding, with the apparatus, the plurality of parameters using one of the plurality of codewords assigned to the selected one of the plurality of portions.

In another aspect, an apparatus comprises a control unit that determines a plurality of parameters, wherein the control unit includes a parameter coding unit that that segments a space that contains the plurality of parameters into a set of portions, wherein the plurality of parameters sum to a constant sum, assigns a different one of a plurality of codewords to each of the portions, selects one of the set of portions that contains a point defined by the plurality of parameters, and codes the plurality of parameters using one of the plurality of codewords assigned to the selected one of the plurality of portions.

In another aspect, an apparatus comprises means for segmenting a space that contains a plurality of parameters into a set of portions, wherein the plurality of parameters sum to a constant sum, means for assigning a different one of a plurality of codewords to each of the portions, means for selecting one of the set of portions that contains a point defined by the plurality of parameters and means for coding the plurality of parameters using one of the plurality of codewords assigned to the selected one of the plurality of portions.

In another aspect, a computer-readable storage medium comprises instructions for causing a programmable processor to segment, with an apparatus, a space that contains a plurality of parameters into a set of portions, wherein the plurality of parameters sum to a constant sum, assign, with the apparatus, a different one of a plurality of codewords to each of the portions, select, with the apparatus, one of the set of portions that contains a point defined by the plurality of parameters and code, with the apparatus, the plurality of parameters using one of the plurality of codewords assigned to the selected one of the plurality of portions.

The details of one or more aspects of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating a video encoding and decoding system.

FIG. 2 is a block diagram illustrating an example of a video encoder shown in FIG. 1 in more detail.

FIG. 3 is a block diagram illustrating an example of an entropy coding unit of FIG. 2 in more detail.

FIG. 4 is a block diagram illustrating an example of a video decoder of FIG. 1 in more detail.

FIG. 5 is a block diagram illustrating an example implementation of a display device that performs parameter encoding techniques to reproduce chromaticity aspects of video data.

FIG. 6 is a flowchart illustrating exemplary operation of a device in implementing the parameter encoding techniques described in the disclosure.

FIGS. 7A-7C are diagrams illustrating segmentation of a determined space in accordance with the parameter coding techniques described in this disclosure.

FIG. 8 is a diagram illustrating a quantization scheme utilizing the parameter coding techniques described in this disclosure.

FIGS. 9A-9D are diagrams illustrating partitioning of a higher order parameter space in accordance with the parameter coding techniques described in this disclosure.

### DETAILED DESCRIPTION

In general, this disclosure is directed to techniques for encoding parameters having a unit sum. A set of parameters have a unit sum when the sum of the set of parameters equals a set unit (which can be normalized to be one). Parameters used for a wide variety of applications may have a unit sum. For example, a display device may employ temporal modulation to reproduce color information for each pixel of any given video frame or image. The display typically includes a number of light sources that correspond to a different color, such as a different one of the three primary colors, red, blue and green. To reproduce the color defined by the color information for each pixel, the display determines a different duration of time for driving each of the three different light sources during a set unit of time, i.e., a frame exposure time in this example. These different durations of time may represent parameters for exposing each of the three different colors that sum to a set unit. Consequently, these parameters may represent a set of parameters having a unit of sum.

As another example, consider filter coefficients for audio data. Often, filter coefficients used in lossless audio compression sum to one. These filter coefficients may be repeatedly sent from an encoder of the audio data to a decoder of the audio data. These filter coefficients may represent parameters of a model used to compress the audio data. These parameters may therefore have unit sum, much as the display parameters described above. Other examples of parameters having unit sum may comprise signal downmix parameters or parameters of a stochastic process (or, in other words, parameters reflective of probabilities). Regardless, parameters having unit sum are often encoded so as to facilitate reproduction of the content data, e.g., the video, image, audio or speech data, or reduction of compression overhead, as two examples.

Rather than eliminate one of the parameters (as this eliminated parameters may be determined by subtracting from one the sum of the other parameters) and encode the remaining subset of parameters resulting from the elimination of the one of the parameters, the techniques set forth in this disclosure encode each and every one of the set of parameters. By encoding each and every one of the parameters, the techniques may improve quantization and subsequent encoding of these parameters by reducing quantization error. The techniques may involve recursive segmentation of a bounded subset of the coordinate space containing the parameters, which may be referred to as a parameter space, into subsequent portions of the parameter space.

Upon segmenting the parameter space into a first set of portions, one of the first set of portions may be selected and the entire set of parameters may be encoded based on the selected one of the first set of portions. The process may repeat, where the selected one of the first set of portions becomes the parameter space, such that the selected one of the first set of portions is segmented into a second set of portions. Based on this selected one of the second set of portions, the parameters may be further coded. In this manner, the techniques may enable optimal coding of parameters that limits quantization error and thereby reduces or limits quantization error.

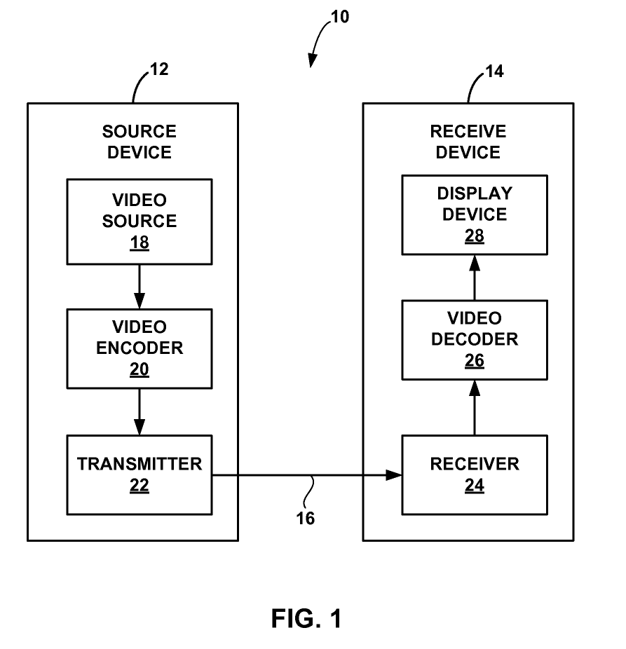

FIG. 1 is a block diagram illustrating a video encoding and decoding system 10. As shown in FIG. 1, system 10 includes a source device 12 that transmits encoded video to a receive device 14 via a communication channel 16. Source device 12 may include a video source 18, video encoder 20 and a transmitter 22. Receive device 14 may include a receiver 24, video decoder 26 and video display device 28. System 10 may be configured to apply techniques for more accurately coding a set of parameters having a unit sum.

A set of parameters have a unit sum when the sum of the values of the set of parameters equals one. Parameters used for a wide variety of applications may have a unit sum. Filter and/or transform coefficients used in encoding video, image, audio and speech data typically sum to one and therefore may represent one example of parameters having unit sum. Signal downmix parameters often sum to one and therefore may represent parameters having unit sum. Chromaticity parameters that control reproduction of chromaticity for a given pixel may also have unit sum as well as parameters of a stochastic process (e.g., a process involving probabilities). For illustrative purposes, the techniques are described below with respect to parameters of a stochastic process and display parameters. Generally, however, the techniques may apply to any set of parameters having unit sum, i.e., that sum to one, including those parameters that sum to one when normalized or undergo other similar mathematical operations. As a result, the techniques should not be limited to the examples described in this disclosure.

In the example of FIG. 1, communication channel 16 may comprise any wireless or wired communication medium, such as a radio frequency (RF) spectrum or one or more physical transmission lines, or any combination of wireless and wired media. Channel 16 may form part of a packet-based network, such as a local area network, wide-area network, or a global network such as the Internet. Communication channel 16 generally represents any suitable communication medium, or collection of different communication media, for transmitting video data from source device 12 to receive device 14.

Source device 12 generates video for transmission to destination device 14. In some cases, however, devices 12, 14 may operate in a substantially symmetrical manner. For example, each of devices 12, 14 may include video encoding and decoding components. Hence, system 10 may support one-way or two-way video transmission between video devices 12, 14, e.g., for video streaming, video broadcasting, or video telephony. For other data compression and coding applications, devices 12, 14 could be configured to send and receive, or exchange, other types of data, such as image, speech or audio data, or combinations of two or more of video, image, speech and audio data. Accordingly, discussion of video applications is provided for purposes of illustration and should not be considered limiting of the various aspects of the disclosure as broadly described herein.

Video source 18 may include a video capture device, such as one or more video cameras, a video archive containing previously captured video, or a live video feed from a video content provider. As a further alternative, video source 18 may generate computer graphics-based data as the source video, or a combination of live video and computer-generated video. In some cases, if video source 18 is a camera, source device 12 and receive device 14 may form so-called camera phones or video phones. Hence, in some aspects, source device 12, receive device 14 or both may form a wireless communication device handset, such as a mobile telephone. In each case, the captured, pre-captured or computer-generated video may be encoded by video encoder 20 for transmission from video source device 12 to video decoder 26 of video receive device 14 via transmitter 22, channel 16 and receiver 24. Display device 28 may include any of a variety of display devices such as a liquid crystal display (LCD), plasma display or organic light emitting diode (OLED) display.

Video encoder 20 and video decoder 26 may be configured to support scalable video coding for spatial, temporal and/or signal-to-noise ratio (SNR) scalability. In some aspects, video encoder 20 and video decoder 22 may be configured to support fine granularity SNR scalability (FGS) coding for SVC. Encoder 20 and decoder 26 may support various degrees of scalability by supporting encoding, transmission and decoding of a base layer and one or more scalable enhancement layers. For scalable video coding, a base layer carries video data with a minimum level of quality. One or more enhancement layers carry additional bitstream to support higher spatial, temporal and/or SNR levels.

Video encoder 20 and video decoder 26 may operate according to a video compression standard, such as MPEG-2, MPEG-4, ITU-T H.263, or ITU-T H.264/MPEG-4 Advanced Video Coding (AVC). Although not shown in FIG. 1, in some aspects, video encoder 20 and video decoder 26 may be integrated with an audio encoder and decoder, respectively, and include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). The H.264 standard is described in ITU-T Recommendation H.264, Advanced video coding for generic audiovisual services, by the ITU-T Study Group, and dated March 2005, which may, in this discloser, be referred to as the H.264 standard or H.264 specification, or the H.264/AVC standard or specification.

In some aspects, for video broadcasting, the techniques described in this disclosure may be applied to Enhanced H.264 video coding for delivering real-time video services in terrestrial mobile multimedia multicast (TM3) systems using the Forward Link Only (FLO) Air Interface Specification, “Forward Link Only Air Interface Specification for Terrestrial Mobile Multimedia Multicast,” to be published as Technical Standard TIA-1099 (the “FLO Specification”), e.g., via a wireless video broadcast server or wireless communication device handset. The FLO Specification includes examples defining bitstream syntax and semantics and decoding processes suitable for the FLO Air Interface. Alternatively, video may be broadcasted according to other standards such as DVB-H (digital video broadcast-handheld), ISDB-T (integrated services digital broadcast-terrestrial), or DMB (digital media broadcast). Hence, source device 12 may be a mobile wireless terminal, a video streaming server, or a video broadcast server. However, techniques described in this disclosure are not limited to any particular type of broadcast, multicast, or point-to-point system. In the case of broadcast, source device 12 may broadcast several channels of video data to multiple receive device, each of which may be similar to receive device 14 of FIG. 1.

Video encoder 20 and video decoder 26 each may be implemented as one or more microprocessors, digital signal processors (DSPs), application specific integrated circuits (ASICs), field programmable gate arrays (FPGAs), discrete logic, software, hardware, firmware or any combinations thereof. Hence, each of video encoder 20 and video decoder 26 may be implemented as least partially as an integrated circuit (IC) chip or device, and included in one or more encoders or decoders, either of which may be integrated as part of a combined encoder/decoder (CODEC) in a respective mobile device, subscriber device, broadcast device, server, or the like. In addition, source device 12 and receive device 14 each may include appropriate modulation, demodulation, frequency conversion, filtering, and amplifier components for transmission and reception of encoded video, as applicable, including radio frequency (RF) wireless components and antennas sufficient to support wireless communication. For ease of illustration, however, such components are not shown in FIG. 1.

A video sequence includes a series of video frames. Video encoder 20 operates on blocks of pixels within individual video frames in order to encode the video data. The video blocks may have fixed or varying sizes, and may differ in size according to a specified coding standard. Each video frame includes a series of slices. Each slice may include a series of macroblocks, which may be arranged into sub-blocks. As an example, the ITU-T H.264 standard supports intra prediction in various block sizes, such as 16 by 16, 8 by 8, 4 by 4 for luma components, and 8×8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components.

Smaller video blocks can provide better resolution, and may be used for locations of a video frame that include higher levels of detail. In general, macroblocks (MBs) and the various sub-blocks may be considered to represent video blocks. In addition, a slice may be considered to represent a series of video blocks, such as MBs and/or sub-blocks. Each slice may be an independently decodable unit. After prediction, a transform may be performed on the 8×8 residual block or 4×4 residual block, and an additional transform may be applied to the DCT coefficients of the 4×4 blocks for chroma components or luma component if the intra 16×16 prediction mode is used.

Video encoder 20 and/or video decoder 26 of system 10 of FIG. 1 may be configured to employ various aspects of the parameter encoding/decoding techniques described in this disclosure. In particular, video encoder 20 and/or video decoder 26 may each include (although not shown in FIG. 1) an encoding unit (which may be referred to as an encoder) and an decoding unit (which may be referred to as a decoder), respectively, that implements at least some of such techniques to promote more precise and flexible encoding and decoding of various aspect of the video data, including parameters related to filter or transform coefficients. In one aspect, the encoder may implement the parameter coding techniques described in this disclosure to code each and every one of a set of parameters that sum to one, rather than code only a subset of the set of parameters. As described below in more detail, encoding the entire set of parameters in this manner may promote more accurate coding of the parameters using approximately, if not exactly, the same number of bits as would be used to code only the subset of parameters.

The encoder may implement this aspect of the parameter coding techniques by first determining the values of the parameters having unit sum. Often, the encoder employs an iterative process to determine the parameters so as to fit a statistical model to a given sample of the video data. A sample, in one aspect, may refer to one or more Discrete Cosine Transform (DCT) coefficients (or a quantized version of these coefficients) for one or more residual blocks. The DCT coefficients represent residual video data for a block in the DCT domain. The residual video data indicate pixel value differences between an original block to be coded and a predictive block selected to predict the original block. In another aspect, a sample may refer to pixel data of one or more residual blocks (or a quantized version of this pixel data), i.e., without application of a transform, in which case the residual pixel values reside in the pixel domain rather than a transform domain. Generally, the sample may refer to any portion of data that corresponds to a statistical distribution that can be modeled by a statistical model.

For example, given a sample of a variable number of letters (e.g., “n” letters) in an alphabet from x₁ to xₙ, the encoder may estimate parameters of the distribution by analyzing the sample and computing the number of occurrences of each letter of the sample. Given this analysis, the encoder may then determine parameters p̂₁ through p̂ₘ. The entropy encoder may then, after determining these parameters, quantize and encode the parameters in accordance with one or more aspects of the parameter coding techniques described in this disclosure.

To begin this quantization and encoding process, the encoder may, in effect, determine a geometry of a space, which may be referred to as a parameter space, that contains a point represented by the parameters p̂₁ through p̂ₘ. This space may reflect a simplex of an order equal to the number of parameters (m) minus one (m−1) and may be referred to as an m−1-simplex. For example, if in equals 3, the entropy encoder may effectively determine a geometry of a space as a 2-simplex. A simplex, as shown below, may be represented as a convex hull of a set of in affinely independent points in Euclidean space of dimension m−1 or higher. A 0-simplex, for example is a point, while a 1-simplex comprises a line. A 2-simplex may be represented as a triangle with three vertices. A 3-simplex is a tetrahedron with 4 vertices. In this respect, simplexes may generally comprise an in ordered polytope or m-polytope.

The encoder may then segment this space containing the parameters into a set of portions. For example, a 2-simplex (which may be represented as an equilateral triangle lying in a plane of a three dimensional space) may be segmented into four equally sized portions, wherein each of these portions represents an equally sized equilateral triangle. The coder may then assign a codeword to each of the portions. The parameters may define a point in the space, and the encoder may select one of the set of portions, e.g., one of the four equilateral triangles in the 2-simplex instance, that contains this point defined by the parameters. The encoder may code the parameters by selecting the codeword assigned to the selected one of the set of portions.

The encoder may continue in a recursive manner to subdivide the selected one of the portions into another set of sub-portions, select one of this other set of sub-portions that contains the point, and encode the parameters based on the selected one of the other set of portions. In effect, the encoder may continually set the geometry of the space to the geometry determined for the previously selected one of the portions, segment this previous selected portion into a further set of portions, select one of this further set of portions that contains the point, and encode the parameters based on this selected one of the further set of portions. The encoder may set a recursive depth or number of recursive iterations to a fixed number that is dependent on a maximum code length or so as to achieve a given level of accuracy.

For example, considering a 2-simplex space, the encoder may segment or otherwise subdivide the equilateral triangle into four equilateral sub-triangle portions. The encoder may assign a codeword to each of these sub-triangle portions, wherein the codeword comprises two bits to represent decimal numbers zero through three. The encoder may then select the one of the sub-triangle portions that contains the point defined by the parameters and encoder the parameters using the codeword assigned to the selected one of the sub-triangle portions. The encoder may then segment the selected one of the sub-triangle portions into another set of four equally sized equilateral triangles (which may be referred to as second iteration triangles), assign a codeword to each of these second iteration triangles, locate the one of these second iteration triangles that contains the point, and encode the parameters by appending the codeword assigned to the selected one of the second iteration triangles to the first codeword assigned during the first recursive iteration. The process may continue until a maximum codeword length is reached or until a set level of accuracy is reached.

After encoding the parameters in this manner, the encoder, such as entropy coder may encode the input sample using the parameters, which may reflect a probability distribution for the symbols of the sample. Once the sample is encoded, entropy coding unit may output the coded sample and the coded parameters as a bitstream, which video encoder 20 may forward to transmitter 22. Transmitter 22 may transmit the bitstream via communication channel 16 to receiver 24. Receiver 24 may forward the bitstream to video decoder 26.

Video decoder 26 may receive the encoded one or more parameters and the encoded sample and begin reconstructing the sample by performing entropy decoding. The entropy decoder of video decoder 26 may implement the parameter decoding aspect of the techniques described in this disclosure. Essentially, the entropy decoder of video decoder 26 may implement the inverse or opposite of the techniques described in this disclosure with respect to the entropy encoder of video encoder 20. To illustrate, the entropy decoder may reconstruct the parameters by parsing each two-bit codeword to recursively locate a portion of the triangular space. Traversing each two-bit codeword in this manner may enable the entropy decoder to determine a portion of the parameter space that contains the point representative of the parameters. From these parameters, the entropy decoder may decode the encoded sample. Video decoder 26 may continue in this manner to decode the video data.

Video decoder 26 may then forward the decoded video data to display device 28. Display device 28 may also implement one or more aspects of the parameter coding techniques described in this disclosure. Display device 28 may include three or more light sources or any other way to produce three or more different colors (e.g., the primary colors, red, green and blue) through temporal modulation. Display device 28 may reproduce color for a pixel, as defined for a frame by the video data, by sequentially activating each of the light sources for a given duration. Display device 28 determines a set of parameters for each pixel color, where each of the parameters may define a different duration during which to drive a separate one of the three different light sources. The set of parameters may therefore represent, as one example, three durations that have a unit sum inasmuch that typically a given video frame defined by the video data specifies a set amount of time that the video frame is to be displayed. This set amount of time may effectively, when normalized, represent one or unity. These display parameters therefore may sum to this set amount of time or one.

Display device 28 may, much like video encoder 20, recursively determines a space and then segment this space into a set of portions. In this instance, the point may represent durations during which to subsequently activate each of, for example, a red light source, a blue light source and a green light source. With respect to these three parameters representative of the durations by which to drive the three primary light sources, display device 28 may initially determine a 2-simplex (as three parameters minus one equals two), segment this 2-simplex into four equally sized equilateral triangles, and assign a codeword to each of these first iteration sub-triangles. Display device 28 may then determine which of the first iteration sub-triangles contains the point and encode the parameters using the codeword assigned to the selected one of the first iteration sub-triangles. Display device 28 may continue in this recursive manner until each bit of the parameters have been encoded.

For example, consider three parameters that each comprises eight-bit duration values representative of the durations for driving the three primary lights sources. Display device 28 may consider a first, most significant bit of each of the values to determine a first point within the 2-simplex and locate this first point within one of the four first iteration sub-triangles. Display device 28 may then encode the parameters with the codeword assigned to this selected one of the first iteration sub-triangles. Display device 28 may then determine a second point from the second-most significant bit of each of the parameters and locate one of the second iteration sub-triangles resulting from the sub-division of the selected one the first iteration sub-triangles that contains this second point. Display device 28 may then encode this second point by appending the codeword assigned to located one of the second iteration sub-triangles to the codeword determined during the first recursive iteration. Display device 28 may continue in this manner until the eighth bit has been traversed and encoded.

The resulting codeword may then represent an encoded form of the parameters identifying varying durations by which to activate a given one of the light sources, where each successive codeword defines a duration that decreases by on order of two, in the instance of a 2-simplex. To illustrate, the first codeword may define a duration for a light source that represents at least a half (½) of the total time or that none of the durations exceed half (½) of the total time. The second codeword may indicate that one of the durations is less than one fourth (¼) of the total time or that all of the durations exceed one fourth (¼) of the total time. The third codeword may indicate that one of the durations exceeds an eight (⅛) of the total time or that none of the durations exceed one ⅛ of the total time. Each codeword therefore reduces the durations by a factor of two, e.g., ½, ¼, ⅛, and so on (or, represented another way, as a factor of ½ⁱ, where i indicates the ith recursive iteration).

Display device 28 may then utilize the range inequalities defined above for each codeword to activate a corresponding one of the light sources for the duration indicated by each of the range of inequalities. In this manner, display device 28 may implement the parameter encoding techniques to segment a unit of time into three or more durations so as to properly reproduce a color for each pixel of a given frame in a series of frames defined by video data. Notably, display device 28 may encode the parameters in near real-time (as slight delays may be acceptable) and output each successive codeword to indicate a duration by which to activate the light source associated with the codeword. In this manner, various aspects of the parameter encoding techniques may facilitate real-time color or chromaticity reproduction to promote color reproduction in reduced complexity displays through temporal modulation.

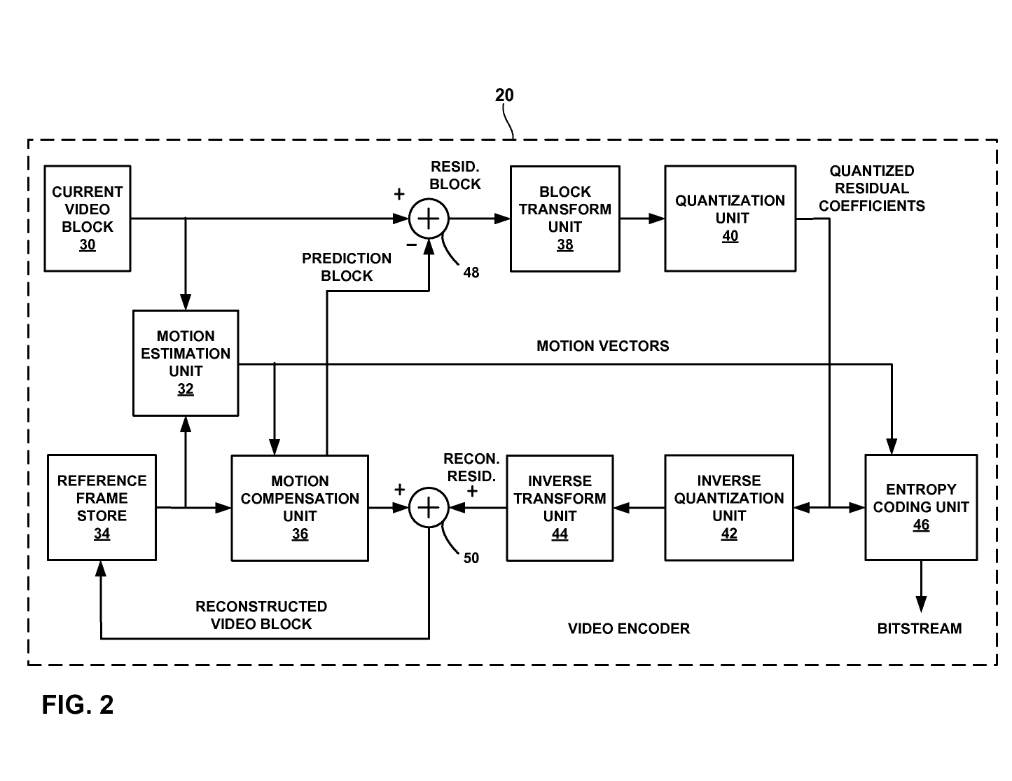

FIG. 2 is a block diagram illustrating an example of a video encoder 20 as shown in FIG. 1. Video encoder 20 may be formed at least in part as one or more integrated circuit devices, which may be referred to collectively as an integrated circuit device. In some aspects, video encoder 20 may form part of a wireless communication device handset or broadcast server. Video encoder 20 may perform intra- and inter-coding of blocks within video frames. Intra-coding relies on spatial prediction to reduce or remove spatial redundancy in video within a given video frame. Inter-coding relies on temporal prediction to reduce or remove temporal redundancy in video within adjacent frames of a video sequence. For inter-coding, video encoder 20 performs motion estimation to track the movement of matching video blocks between adjacent frames.

As shown in FIG. 2, video encoder 20 receives a current video block 30 within a video frame to be encoded. In the example of FIG. 2, video encoder 20 includes motion estimation unit 32, reference frame store 34, motion compensation unit 36, block transform unit 38, quantization unit 40, inverse quantization unit 42, inverse transform unit 44 and entropy coding unit 46. An in-loop deblocking filter (not shown) may be applied to filter blocks to remove blocking artifacts. Video encoder 20 also includes summer 48 and summer 50. FIG. 2 illustrates the temporal prediction components of video encoder 20 for inter-coding of video blocks. Although not shown in FIG. 2 for ease of illustration, video encoder 20 also may include spatial prediction components for intra-coding of some video blocks.

Motion estimation unit 32 compares video block 30 to blocks in one or more adjacent video frames to generate one or more motion vectors. The adjacent frame or frames may be retrieved from reference frame store 34, which may comprise any type of memory or data storage device to store video blocks reconstructed from previously encoded blocks. Motion estimation may be performed for blocks of variable sizes, e.g., 16×16, 16×8, 8×16, 8×8 or smaller block sizes. Motion estimation unit 32 identifies one or more blocks in adjacent frames that most closely matches the current video block 30 and determines displacement between the blocks in adjacent frames and the current video block. On this basis, motion estimation unit 32 produces one or more motion vectors (MV) that indicate the magnitude and trajectory of the displacement between current video block 30 and one or more matching blocks from the reference frame or frames used to code current video block 30.

Motion vectors may have half- or quarter-pixel precision, or even finer precision, allowing video encoder 20 to track motion with higher precision than integer pixel locations and obtain a better prediction block. When motion vectors with fractional pixel values are used, interpolation operations are carried out in motion compensation unit 36. Motion estimation unit 32 identifies the best block partitions and motion vector or motion vectors for a video block using certain criteria. For example, there may be more than one motion vector in the case of bi-directional prediction. Using the resulting block partitions and motion vectors, motion compensation unit 36 forms a prediction video block.

Video encoder 20 forms a residual video block by subtracting the prediction video block produced by motion compensation unit 36 from the original, current video block 30 at summer 48. The residual video block comprises an array of residual pixel values, indicating differences, i.e., error, between corresponding pixels in the prediction video block and the current video block to be coded. Block transform unit 38 applies a transform, such as a discrete cosine transform or an integer transform, e.g., the 4×4 or 8×8 integer transform used in H.264/AVC, to the residual block, producing residual transform block coefficients. Quantization unit 40 quantizes (e.g., rounds) the residual transform block coefficients to further reduce bit rate. Entropy coding unit 46 entropy codes the quantized coefficients to even further reduce bit rate.

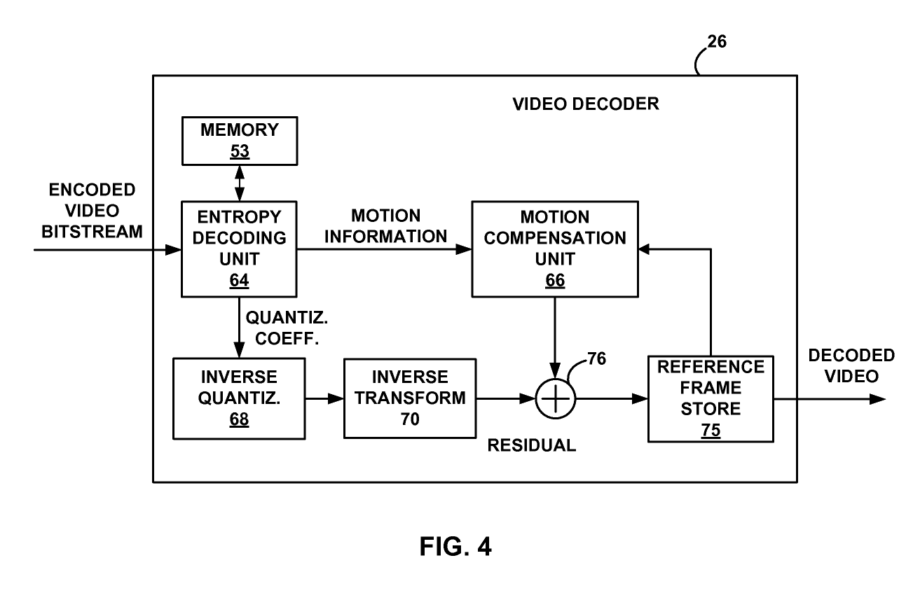

Entropy coding unit 46 operates to code the quantized block coefficients. Hence, the various encoding processes described in this disclosure may be implemented within entropy coding unit 46 to perform coding of video data. Alternatively, such an entropy coding unit 46 may perform the processes described in this disclosure to code any of a variety of data, including but not limited to video, image, speech and audio data. In general, video decoder 26 performs inverse operations to decode and reconstruct the encoded video, as will be described, e.g., with reference to FIG. 4.

Inverse quantization unit 42 and inverse transform unit 44 apply inverse quantization and inverse transformation, respectively, to reconstruct the residual block. Summer 50 adds the reconstructed residual block to the motion compensated prediction block produced by motion compensation unit 36 to produce a reconstructed video block for storage in reference frame store 34. The reconstructed video block is used by motion estimation unit 32 and motion compensation unit 36 to encode a block in a subsequent video frame.

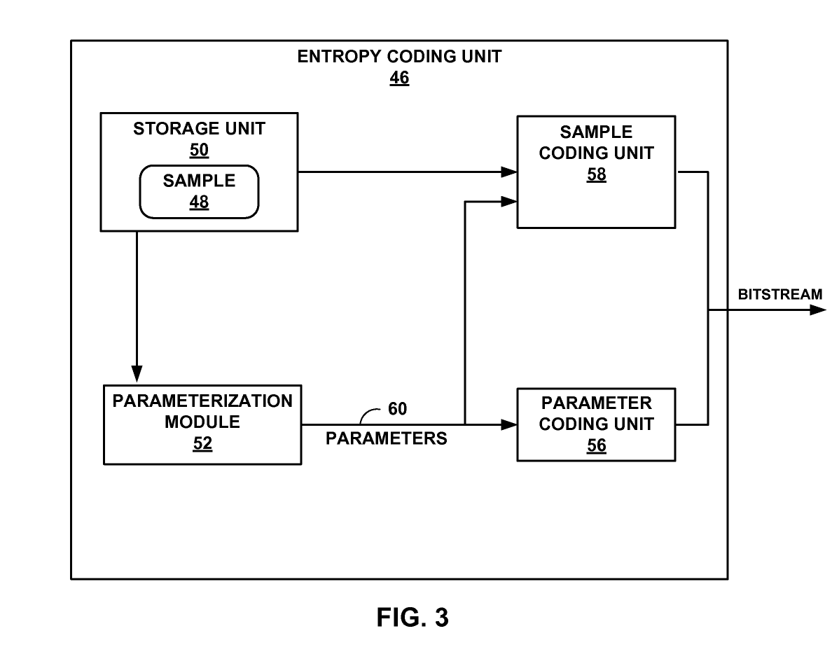

FIG. 3 is a block diagram illustrating an example of entropy coding unit 46 of FIG. 2 in more detail. As shown in FIG. 3, entropy coding unit 46 receives a sample 48 to be encoded, where the sample may, for example, include quantized transform (e.g., DCT) coefficients or pixel values. In the example of FIG. 3, entropy coding unit 46 includes storage unit 50, a parameterization unit 52, a parameter coding unit 56 and a sample coding unit 58. Although not shown in FIG. 3, entropy coding unit 46 may include other modules for encoding the other information described above, such as a motion vector coding unit that encodes motion vector information. The techniques therefore should not be limited to the example entropy coding unit 46 shown in FIG. 3.

Entropy coding unit 46 receives sample 48, which as described above may comprise quantized DCT coefficients, and stores sample 48 to storage unit 50. Storage unit 50 may comprise a computer-readable storage medium, such as a such as random access memory (RAM), synchronous dynamic random access memory (SDRAM), read-only memory (ROM), non-volatile random access memory (NVRAM), electrically erasable programmable read-only memory (EEPROM), FLASH memory, magnetic or optical data storage media, any other type of memory or storage device capable of storing sample 48, or any combination of the foregoing memories or storage devices. While described as residing internally to entropy coding unit 46, storage unit 50 may reside externally from entropy coding unit 46, with entropy coding unit 46 accessing storage unit 50 to retrieve sample 48.

Parameterization module 52 may access storage unit 50 to retrieve sample 48. Parameterization module 52 may represent a hardware or combination hardware and software module that determines parameters 60. Parameterization module 52 may determine parameters 60 using an iterative process to estimate parameters 60 that describe a distribution of symbols. More specifically, parameterization module 52 may determine a parameter p̂ᵢ that estimates a probability of an i-th symbol, xᵢ, in a sample x₁, . . . , xₙ based on the number of occurrences of the ith symbol, xᵢ, in the sample x₁, . . . , xₙ, which may be denoted as rᵢ(x₁, . . . , xₙ). Parameterization module 52 may, in one instance, determine parameter p̂ᵢ in accordance with the following equation (1):

p̂ᵢ=(rᵢ(x₁, . . . , xₙ)+½)/(n+m/2), (1)

where n denotes the number of symbols in the sample, x₁, . . . , xₙ, and m denotes the number of parameters in a set of parameters, p̂₁, . . . , p̂ₘ, where the set of parameters p̂₁, . . . , p̂ₘ sum to one. Parameterization module 52 may determine these parameters p̂₁, . . . , p̂ₘ and transmit these parameters as parameters 60 to both parameter coding unit 56 and sample coding unit 58.

Parameter coding unit 56 may quantize and code parameters 60 received from parameterization module 52. Parameter coding unit 56 may implement various aspects of the parameter coding techniques described in this disclosure. Parameter coding unit 56 may determine an (m−1)-simplex that contains the set of parameters p̂₁, . . . , p̂ₘ, where m as noted above denotes the number of parameters in the set of parameters p̂₁, . . . , p̂ₘ, and segment or otherwise subdivide this (m−1)-simplex into a set of first iteration portions. The parameters p̂₁, . . . , p̂ₘ may define a point within the (m−1)-simplex and parameter coding unit 56 may locate or otherwise determine one of the set of first iteration portions that contains this point. Parameter coding unit 56 may assign a codeword in a set manner to each of the set of first iteration portions and code the point with respect to this first recursive iteration using the codeword assigned to the determined one of the first iteration portions.

Parameter coding unit 56 may then segment the selected one of the first iteration portions into a set of second iteration portions, assign a codeword in the same manner to each of the set of second iteration portions, and determine one of the second iteration portions that contains the point. Parameter coding unit 56 may then code the point further by appending the codeword assigned to the determined one of the second iteration portions to the codeword determined in the first recursive iteration. Parameter coding unit 56 may continue in this recursive manner until parameters 60 are coded to a set accuracy or until a certain set number of iterations are performed. Parameter coding unit 56, by limiting the iterations, naturally quantizes parameters 60 during the encoding of parameters 60. However, in some instances, parameter coding unit 56 may overlay the (m−)-simplex with a hexagonal lattice to derive coordinates for hexagonal cells. In the 2-simplex case, parameter encoding unit 56 may utilize the underlying triangular partitions or portions to derive coordinates of the hexagonal cells and centroids of such hexagonal cells. Using these hexagonal cells, parameter encoding unit 56 may further improve quantization so as to reduce quantization error.

Meanwhile, sample coding unit 58 may receive sample 48 and parameters 60 and determine a code based on a probability distribution defined by parameters 60. Sample coding unit 58 may, in one aspect, perform arithmetic coding to code sample 48, e.g., quantized DCT coefficients, according to the probability distribution defined by parameters 60. Based on this probability distribution, sample coding unit 58 may perform arithmetic coding to determine a codeword representative of sample 48. Parameter coding unit 56 and sample coding unit 58 may output these coded parameters and sample as a portion of the bitstream for transmittal to a decoder, such as video decoder 26.

FIG. 4 is a block diagram illustrating an example of video decoder 26 of FIG. 1. Video decoder 26 may be formed at least in part as one or more integrated circuit devices, which may be referred to collectively as an integrated circuit device. In some aspects, video decoder 26 may form part of a wireless communication device handset. Video decoder 26 may perform intra- and inter-decoding of blocks within video frames. As shown in FIG. 3, video decoder 26 receives an encoded video bitstream that has been encoded by video encoder 20. In the example of FIG. 4 video decoder 26 includes entropy decoding unit 64, motion compensation unit 66, inverse quantization unit 68, inverse transform unit 70, and reference frame store 74. Entropy decoding unit 64 may access one or more data structures stored in a memory 63 to obtain data useful in coding. Video decoder 26 also may include an in-loop deblocking filter (not shown) that filters the output of summer 76. Video decoder 26 also includes summer 76. FIG. 4 illustrates the temporal prediction components of video decoder 26 for inter-decoding of video blocks. Although not shown in FIG. 4, video decoder 26 also may include spatial prediction components for intra-decoding of some video blocks.

Entropy decoding unit 64 receives the encoded video bitstream and decodes from the bitstream quantized residual coefficients and quantized parameters, as well as other information, such as macroblock coding mode and motion information, which may include motion vectors and block partitions. For example, in order to decode quantized parameters and sample from the encoded bitstream, like entropy coding unit 46 of FIG. 3, entropy decoding unit 64 of FIG. 4 may perform the inverse of the aspects of the techniques described with respect to entropy coding unit 46 of FIG. 3 in order to retrieve the parameters and sample from the encoded bitstream. Hence, the various decoding processes described in this disclosure may be implemented within entropy decoding unit 64 to perform decoding of video data. Alternatively, entropy decoding unit 64 may perform the processes described in this disclosure to decode any of a variety of data, including but not limited to video, image, speech and audio data. In either case, the result of the coding performed by entropy decoding unit 64 may be output to a user, stored in memory and/or transmitted to another device or processing unit.

Motion compensation unit 66 receives the motion vectors and block partitions and one or more reconstructed reference frames from reference frame store 74 to produce a prediction video block. Inverse quantization unit 68 inverse quantizes, i.e., de-quantizes, the quantized block coefficients. Inverse transform unit 70 applies an inverse transform, e.g., an inverse DCT or an inverse 4×4 or 8×8 integer transform, to the coefficients to produce residual blocks. The prediction video blocks are then summed by summer 76 with the residual blocks to form decoded blocks. A deblocking filter (not shown) may be applied to filter the decoded blocks to remove blocking artifacts. The filtered blocks are then placed in reference frame store 74, which provides reference frame for decoding of subsequent video frames and also produces decoded video to drive display device 28 (FIG. 1).

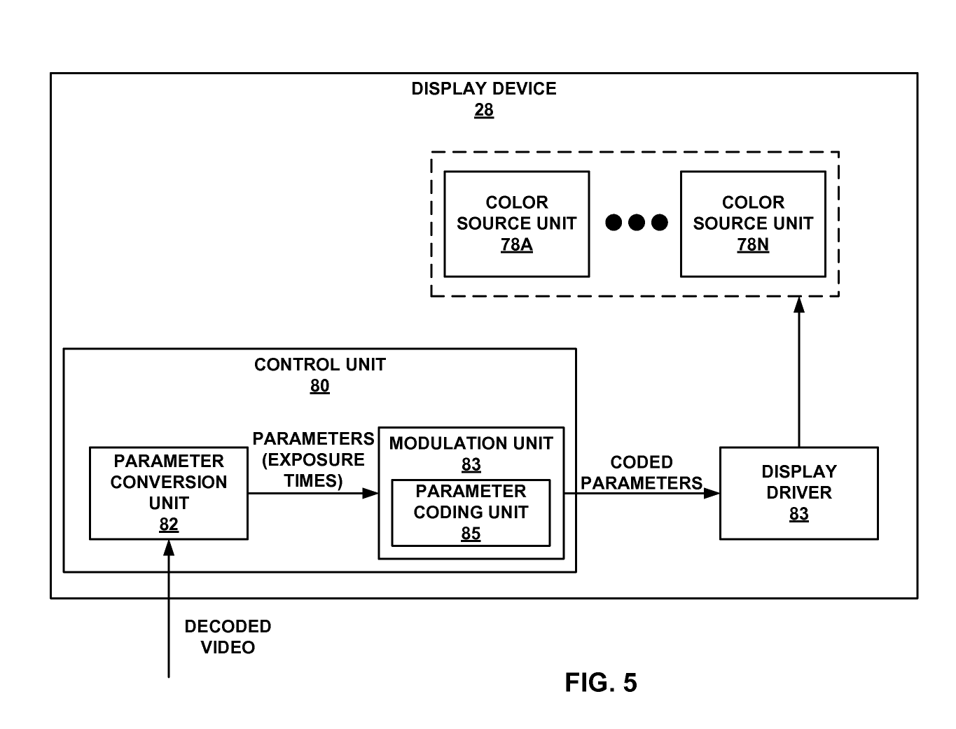

FIG. 5 is a block diagram illustrating an example implementation of display device 28 that performs various aspects of the parameter encoding techniques to efficiently and more accurately reproduce color aspects of video data. Display device 28 may generally comprise a device that displays video and/or image data using a plurality of color sources, which are shown in FIG. 5 as color source units 78A-78N (“color source units 78”). Color source units 78 may comprise in some instances individual light sources that each generates light of a specific wavelength, which is better known as a specific color. In other instances, color source units 78 may comprise a single light source (e.g., typically a white light source) and various mechanisms, modules or other supporting units, such as a color wheel, liquid crystal element, or other device, that produces light of a particular wavelength or color. In this respect, color source units 78 may be considered distinct sources of light of a particular wavelength or color.

Display device 28 may also, as shown in the example of FIG. 5, include a control unit 80. Control unit 80 may comprise any combination of hardware and software that implement the techniques described in this disclosure. Control unit 80 may comprise one or more processors, Application Specific Integrated Circuits (ASICs), integrated circuits or any other processing or control unit or element or combination thereof, and a memory or storage device. In some instances, the memory or storage device (e.g., generally, a computer-readable storage medium) may comprise the above described instruction that cause the programmable processor to perform the techniques described in this disclosure. These instructions may form a computer or software program or other executable module that the programmable processor executes to perform the functionality described herein, including the functionality attributed to the techniques of this disclosure.

Control unit 80 includes a parameter conversion unit 82 that receives decoded video data, including color data for each pixel of a video frame in the plurality of video frames representative of a video sequence. Parameter conversion unit 82 evaluates the color data and converts this color data into a set of parameters, each of which is representative of a time duration or exposure time for driving a different one of color source units 78, as described above. Control unit 80 also includes a modulation unit 83 that performs temporal modulation. For example, modulation unit 83 may temporally mix red, green and blue channels, assuming each channel has a means for controlling its brightness. Modulation unit 83 may represent a module or other component comprising hardware or a combination of hardware and software that determines a sequence by which to activate color source units 78 based on the parameters determined by parameter conversion unit 82.

Modulation unit 83 may determine this sequence as two or more of color source units 78 may not be driven simultaneously. Rather, only one of color source units 78 may be driven at a time, which is not to suggest that some minimal overlap in driving color source units 78 may not occur. Thus, while described in absolutes of only one of color source units 78 being driven at a time, this should not be construed to mean that some minimal overlap in driving color source units 78 may not occur in operation but only that, given this minimal overlap, only one of color source units 78 may be driven at any given time. Modulation unit 83 may include a parameter coding unit 85 that encodes the set of parameters, e.g., the exposure times, in accordance with the parameter coding techniques described in this disclosure. Parameter coding unit 85 may comprise hardware or a combination of hardware and software that implements these techniques so as to generate a sequence of codewords that encode the parameters. Each of the codewords may identify one of color source units 78 and the duration for which to activate the identified one of the color source units 78.

Display device 28 also includes a source controller 84. Source controller 84 may represent a module or other component comprising hardware and/or a combination of hardware and software that controls or otherwise drives color source units 78. Source controller 84 may, as described above, drive color source units 78 sequentially, with possible overlap, such that two or more of color source units 78 are not driven at the same time (outside of some minimal overlap due to operational constraints). Source controller 84 may activate or otherwise enable one of color source units 78 based on the encoded parameters output by parameter coding unit 85.

While shown as including control unit 80, display device 28 may not include a control unit or other processing element and may instead solely include color source units 78 and source controller 84. Another device, e.g., a driving device, may include control unit 80 so as to determine coded parameters to source controller 84. Display device 28 may in these instances provide an interface by which to receive these coded parameters from the driver device, e.g., a digital video player, a receiver, a digital media player, or any other type of device capable of encoding chromaticity values for pixels of a frame defined by video data.

To illustrate this color application of various aspects of the techniques, it is assumed that display device 28 includes three color source units 78, one for each of the three primary colors, e.g., red, green and blue. Parameter conversion unit 82 of control unit 80 may initially receive the decoded video from a video decoder, such as video decoder 26. The decoded video may define color values for each pixel in a frame of a series of frames defined by the decoded video data. These color values may comprise a set of values, one value for each of the three primary colors. Each of these color values may represent colors of a mixture that defines a composite color. Parameter conversion unit 83 evaluates these color values or data to determine three parameters that each represents a different exposure time for a corresponding one of three color source units 78. Parameter conversion unit 83 then forwards these three parameters representative of the exposure times to modulation unit 83.

With respect to this exemplary set of three parameters, parameter conversion unit 85 of modulation unit 83 may encode these parameters in accordance with the parameter encoding techniques set forth in this disclosure. Parameter coding unit 85 may first determine a geometry of the space as a 2-simplex (as the number of parameters, three, minus one equals two) and segment this 2-simplex into a set of first iteration portions. Parameter coding unit 85 may assign codewords to each one of the first iteration portions, select the one of the first iteration portions that contains a point within the 2-simplex defined by the three parameters, and encode the parameters using the codeword assigned to the selected one of the first iteration portions. As described above, parameter coding unit 85 may continue to recursively segment the selected one of the portions based on, as one example that is described in more detail below, the precision of the set of parameters, e.g., how many bits are used to define each of the parameters.

Parameter coding unit 85 may output each codeword as it is determined to source controller 84, which may, based on the codeword, activate one of color source units 78 for a set duration. Given a precision of 10 bits for the above three parameters (which as described below may translate into 10 recursive iterations), parameter coding unit 85 may output encoded parameters as a string of two bit symbols 10 01 00 01 10 00 10 11 01 10, where each of these two-bit symbols identifies a successive z-th iteration portion, z denoting an integer from one to ten.

In response to the first symbol of the string of two-bit symbols, source controller 84 may determine to activate one of color source units 78 for a half (½) of a span of time specified by a header for the frame that includes this pixel, where this span of time represents the span of time that this frame is to be displayed. In response to the second symbol, source controller 84 may activate a different one of color source units 78 (as the second symbol is different from the first) for a quarter (¼) of the span of time. Notably, each successive symbol may divide the remaining amount of the span of time in half. To illustrate, the remaining amount of the span of time after the first iteration is the entire span of time minus a half, which equals a half. The next symbol then divides the remaining span of time (½) in half, thereby specifying an activation duration of ¼ of the span of time. The third iteration may divide the remaining quarter of the span of time by two to specify an activation duration of an eighth (⅛). Yet, in the example above, the third two-bit symbol of 00 defines a symbol for which this recursive algorithm may be adjusted.

To illustrate, consider another exemplary point much like the above exemplary point defined by three parameters, whose values are 0.333 for each of the durations for driving red and blue color and 0.334 for green. This second exemplary point may lie in the middle of the 2-simplex nearly equidistant from each of the three vertexes of the triangular shaped 2-simplex. Parameter coding unit 85 locates a first iteration partition or portion in the middle of the 2-simplex that contains this point. Yet, as explained in more detail below, the codeword assigned to this portion may not suggest that any one of the three color source units 78 should be activated for more than a half (½). Rather, this codeword may indicate that the duration each of the three light sources should be activated is less than a half (½) of the span of time. In other words, because these second exemplary parameters are equally weighted in terms of reflecting durations to reflect the color mixture, none of them are predominant and the second iteration may be required to more accurately resolve the durations.

When encountering this two-bit symbol of 00, source controller 84 may proceed to the next symbol 01 and review this symbol within the context of the previous symbol 00, where symbol 00 in this instance may indicate that the point lies in one of a set of third iteration portions that indicates none of the parameters within the selected one of the third iteration portion exceed ⅛ of the remaining span of time. This symbol 00 effectively denotes the upper bound on each of the three parameters for the third iteration. The next symbol 01 may then indicate that the activation time of one of the three color source units 78 is less than one sixteenth ( 1/16) of the span of time while the remaining activation durations or times for the remaining other two color source units 78 is greater than a sixteenth ( 1/16) but less than an eighth (⅛). Source controller 84 may then activate the other two of the color source units 78 for consecutive sixteenths of the remaining time, before considering the next symbol defining the coded parameters. Source controller 84 may continue in this manner until reaching the last symbol defining a coded parameter and then repeat this process for each pixel in the frame so as to display the frame for the span of time defined in its header.

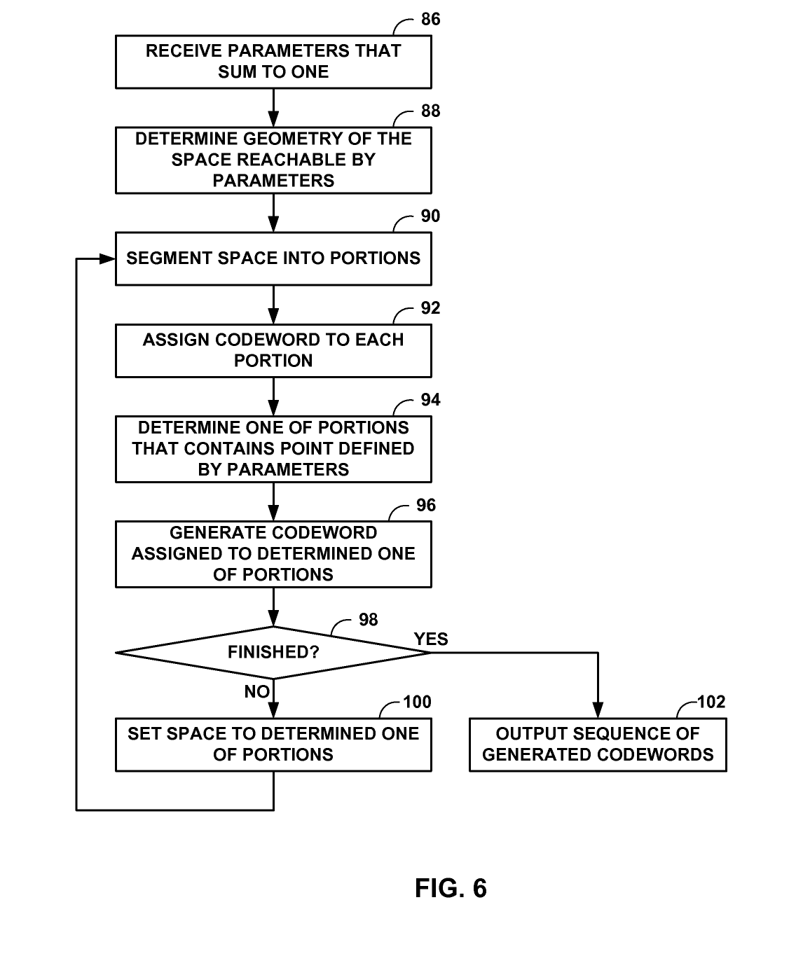

FIG. 6 is a flowchart illustrating exemplary operation of a device, such as display device 28 of FIG. 5, in implementing the parameter encoding techniques described in the disclosure. While described with respect to display device 28, the techniques may be implemented by a wide variety of devices, such as video encoder 20 and video decoder 26 (although in the inverse) of FIGS. 1-4, and adapted to a wide variety of applications, e.g., compression. The techniques may be applied to encode any set of parameters that sum to one (or have unit sum) and therefore should not be limited to the exemplary applications described in this disclosure.

Initially, a parameter conversion unit 82 of control unit 80 may receive decoded video data defining color data for each pixel in a video frame of a sequence of video frames. Parameter conversion unit 82 may then convert this color data for each pixel into a set of parameters representative of time durations during which to drive a respective one of light source units 78, as described above. These parameters, as noted above, sum to one (86). Parameter coding unit 85 may, in response to these parameters, determine a space that contains all possible parameter value combinations, which in other words, may represent a space reachable by the parameters (88). Considering that each parameter may comprise a value in a range of zero to one (due to the unit sum bound), parameter coding unit 85 may determine the geometry of the space as a 2-simplex to represent these three parameters.

Parameter coding unit 85 may then segment this space into a set of first iteration portions, assign a codeword to each one of these first iteration portions, and determine one of these portions that contains a point defined by the three parameter values, as briefly described above and illustrated below in greater detail (90-94). Parameter coding unit 85 may then generate the encoded parameter, i.e., the codeword assigned to the determine one of the first iteration portions in this example (96). Parameter coding unit 85 may then evaluate whether to continue iterating in this recursive manner, e.g., whether to finish iterating (98), and may base this evaluation on an accuracy of the parameters, e.g., a number of bits used to encode the parameters, as described above.

If not finished (“NO” 98), parameter coding unit 85 may set the space to the determined one of the set of portions that contains the point and perform another recursive iteration (100). This iteration may involve segmenting the space, e.g., to determine one of the first iteration portions, to generate a set of second iteration portions, assigning a codeword to each of these second iteration portions, determining one of these second iteration portions that contains the point defined by the parameters, and encoding the parameters by appending the codeword assigned to the determine one of the second iteration portions to the codeword assigned to the determine one of the first iteration portions (90-96). If finished (“YES” 98), parameter coding unit 85 may output the coded parameters, e.g., as a string of successive codewords (102).

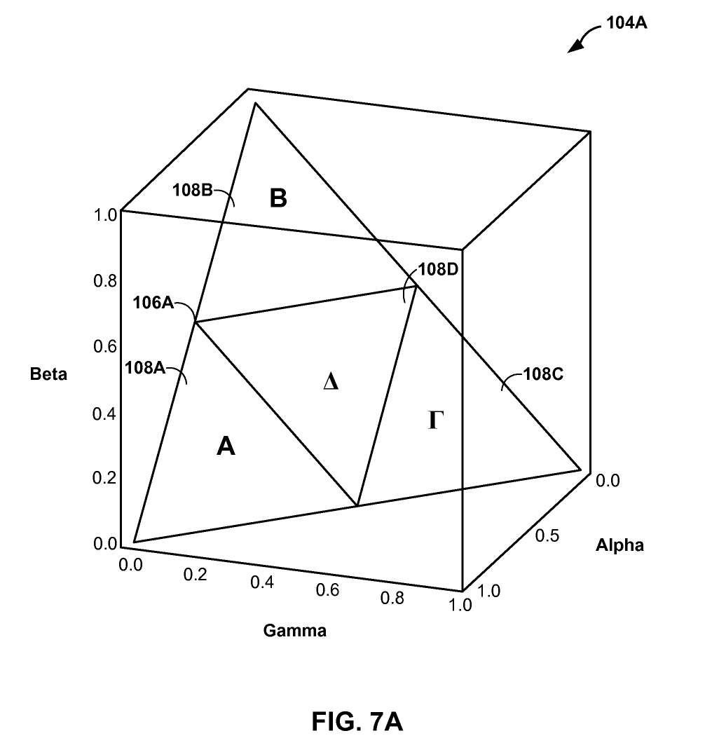

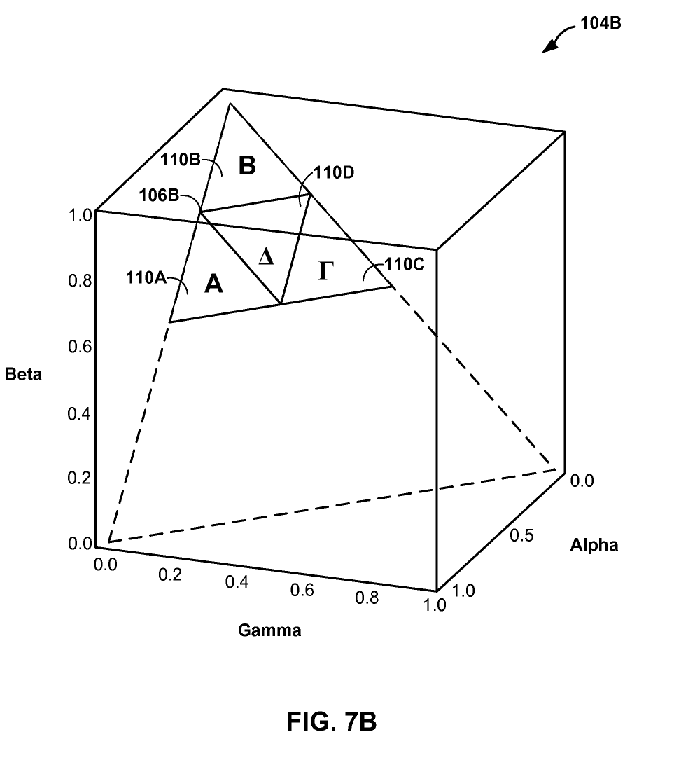

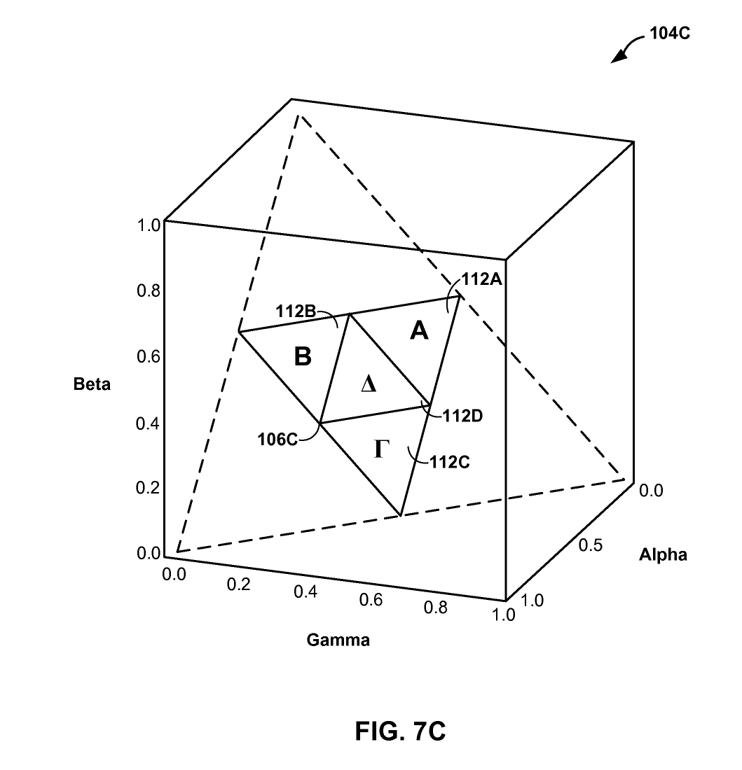

FIGS. 7A-7C are diagrams illustrating graphs 104A-104C in which a space is segmented in accordance with the parameter coding techniques described in this disclosure. FIG. 7A is a diagram illustrating graph 104A in which space 106A is segmented during a first iteration of the recursive parameter coding techniques described in this disclosure. Space 106A may represent a 2-simplex that contains all possible values for three parameters referred to as alpha (α), Beta (β), and gamma (γ). These parameters may represent parameters of a mixture, such as parameters defining durations for light source units to recreate a color mixture. Alpha may comprise a parameter that identifies a duration for driving a red color light source. Beta may comprise a parameter that identifies a duration for driving a green color light source. Gamma may comprise a parameter that identifies a duration for driving a blue color light source.

As shown further in the example of FIG. 7A, space 106A may comprise an equilateral triangle that resides in a plane of three-dimensional axes defined by three parameters. Parameter coding unit 85 may segment space 106A into four first iteration portions shown in FIG. 7A as first iteration portions 108A-108D (“first iteration portions 108”). Each of first iteration portions 108 may comprise same-sized equilateral triangles. First iteration portions 108 may be characterized by ranges of one or more of the three parameters, alpha, beta and gamma.

For example, first iteration portion 108A, which is assigned a codeword “A,” may be characterized by noting that portion 108A contains points with alpha greater than or equal to a half (½ or 0.5) and beta and gamma both less than a half (½ or 0.5). Portion 108B, which is assigned a codeword “B,” may be characterized by noting that portion 108B contains points with beta greater than or equal to a half (½ or 0.5) and alpha and gamma both less than a half (½ or 0.5). Portion 108C, which is assigned a codeword “Γ,” may be characterized by noting that portion 108C contains points with gamma greater than or equal to a half (½ or 0.5). Portion 108D, which is assigned a codeword “Δ,” may be characterized by noting that portion 108D contains points with alpha, beta and gamma each being less than a half (½ or 0.5). Accordingly, portions 108 may be denote the following ranges:
A: α≧½, and β, γ<½
B: β≧½, and α, γ<½
Γ: γ≧½, and α, β<½
Δ: α, β, γ<½.
   Given these ranges, parameter coding unit 85 may determine which of portions 108 include a point defined by a particular set of these three parameters.

To illustrate, assume alpha equals 0.299, beta equals 0.587 and gamma equals 0.114. Given that beta is greater than or equal to 0.587, parameter coding unit 85 may determine that portion 108B contains the point defined by the three parameters and select codeword “B” to code the parameters. As there are four codewords, each codeword may be represented as two-bits, such that A is denoted by two-bit codeword 01, B is denoted by two-bit codeword 10, Γ is denoted by two-bit codeword 11, and Δ is denoted by two-bit codeword 00. Parameter coding unit 85 may then code these parameters as two-bit codeword 10. After coding these parameters, parameter coding unit 85 may determine whether to continue in this recursive manner Assuming parameter coding unit 85 continues to code the parameters, parameter coding unit 85 may set the space to portion 108B.

FIG. 7B is a diagram illustrating a graph 104B in which a space 106B is segmented during a second iteration of the recursive parameter coding techniques described in this disclosure. In the example of FIG. 7B, space 106B is set to portion 108B to continue the example discussed above, with the remaining portion of space 106A denoted by a dashed line. Space 106B is bounded in that parameter beta, during the first iteration, is determined to be greater than 0.5 while both alpha and gamma are greater than the size of the size of the space 106A (where the size of the side is equal to the square root of two or 2^{1/2}) divided by four (2^{1/2}/4) translated to the alpha and gamma axis but less than the size of the original space minus this size divided by four (2^{1/2}−(2^{1/2}/4)) translated to the alpha and gamma axis. This range for alpha and gamma is 0.25 through 0.75.

Parameter coding unit 85 may, after determining the geometry of this space 106B, segment this space 106B into second iteration portions 110A-110D (“second iteration portions 110”) and assign codewords to second iteration portions 110A-110D in the same set manner as assigned above with respect to first iteration portions 108. Parameter coding unit 85 may then determine one of portions 110 that contain the point defined by the exemplary parameters set to the values indicated above. Again, portions 110 may be characterized by ranges with respect to the second iteration. These ranges may be defined as follows:
A: α≧¼, and β, γ<¼
B: β≧¼, and α, γ<¼
Γ: γ≧¼, and α, β<¼
Δ: α, β, γ<¼.
   This parameters may define the amount of the remaining time (e.g., the remaining half for the second iteration) is to be used to display a subsequent color.

In this instance, parameter coding unit 85 may determine that portion 110A contains the point defined by the alpha, beta and gamma parameters with values indicated above. By selecting this portion 110A and encoding the parameter values as a string of codewords 10 01 (“B” or 10 from the first iteration and “A” or 01), parameter coding unit 85 may effectively indicate that the green light source (which is associated with the beta duration parameter) is to be driven for half of the time specified by the frame and the red light source (which is associated with the alpha duration parameter) is to be driven for a quarter of the time specified by the frame. This coding may continue recursively until a desired accuracy is achieved.

The above example demonstrated two iterations that segmented portions oriented in the same manner. Notably, however, portion 108D shown in FIG. 7A is oriented differently than both of spaces 106A, 106B. Further, if portion 108D contains the point, none of the parameters contain at least one half of the total time. Instead, each of the three parameters represent less than half of the total time. For these inverse oriented portions, such as portion 108D which is oriented inversely from spaces 106A, 106B, parameter encoding unit 83 may determine inverse ranges, which is discussed below in more detail with respect to FIG. 7C.

FIG. 7C is a diagram illustrating a graph 104C in which a space 106C is segmented during a second iteration of the recursive parameter coding techniques described in this disclosure. In the example of FIG. 7C, space 106C is set to portion 108D with the remaining portion of space 106A denoted by a dashed line. space 106C is bounded in that parameters alpha, beta, and gamma were encoded during the first iteration to be less than a half of the total time. For example, assuming alpha equals 0.450, beta equals 0.350 and gamma equals 0.200, parameter coding unit 85 would have selected portion 108D as containing the point defined by these parameters. Parameter coding unit 85 would have then determined space 106C and segmented space 106C in the manner shown in FIG. 7C to generate second iteration portions 112A-112D (“second iteration portions 112”).

Parameter coding unit 85 next determines which of portions 112 contain the point defined by the parameters. Portions 112 may be characterized as defining ranges and in this instance may define the following ranges:
A: α<¼, and β, γ≧¼
B: β<¼, and α, γ≧¼
Γ: γ<¼, and α, β≧¼
Δ: α, β, γ≧¼.
   Notably, when segmenting an inverse oriented portion, such as space 106C, parameter coding unit 85 determines inverse ranges, whereby selecting one of portions 112 that contain the point indicates that the color/parameter associated with that selected one of portions 112 makes up less, not greater, than 1/(2ⁱ), where i denotes the iteration, of the total time. As this is the second iteration, parameter coding unit 85 may determine whether the parameters comprise less than ¼ of the total time, as noted in the above range inequalities.

As these are the only variations, parameter coding unit 85 may for two-simplex spaces recursively perform these iterations to partition a mixture parameter space, which may be denoted as Θ, to progressively yield smaller regions of the same shape. This recursive scheme may be characterized in two ways. First, for every iteration, there is a two-times reduction in range of all three parameters. Second, again for every iteration, there is a four-times reduction in the area of the portions.

Given this recursive scheme, any point, such as a point Q, with parameters alpha, beta and gamma in a two-simplex can then be specified as a sequence:
Q=q₁ q₂ q_{3 . . .}
   where q₁ is the symbol determined from the first iteration, q₂ is the symbol determined from the second iteration, and so on. Each of these symbols may be represented mathematically as:

q₁ε{A,B,Γ,Δ}, i=1,2, . . .

This description is unique and can be mapped into bits (2 bits per symbol), thereby allowing Q to be stored and used as a normal binary sequence. Moreover, there is a pair of one-to-one mappings between individual bits of parameters alpha, beta and gamma and the resulting symbols qᵢ in the sequence such that the following numerical code can be used:
1<->A
2<->B
3<->Γ
0<->Δ

Given this numerical code, parameter coding unit 85 may determine the symbol for the partition of upward oriented triangles (those that result in greater than equalities) in accordance with the following equation (2):

qᵢ=αᵢ+2βᵢ+3γᵢ. (2)

Similarly, for downward oriented triangles, parameter coding unit 85 may determine the symbol for a partition in accordance with the following equation (3):

qᵢ=6−(αᵢ+2βᵢ+3γ)ᵢ. (3)

This switch in orientations may only occur when parameter coding unit 85 identifies that portion 108D or, more generally, a region Δ contains the point. In effect, a Boolean state may regulate which of the above formulae to use.

Given these two equations and noting the Boolean state, parameter coding unit 85 may convert between parameters alpha, beta and gamma and the sequential representation Q in an efficient manner by parsing individual bits of those parameters. To illustrate, consider the following code in the C programming language that implements the parameter encoding techniques to encode an alpha parameter of value 0.299, a beta parameter of value 0.587 and a gamma parameter of value 0.114:

/* q_code c -- demonstration of conversion of unit-sum
* parameters into a sequential representation corresponding
* to recursive partitioning of their simplex */
#include <stdio.h>
#include <math.h>
/*
* Convert tripple of parameters into a partition code.
*/
unsigned int q_code (unsigned int alpha, unsigned int beta,
unsigned int gamma, int b)
{

| | |
|---|---|
| unsigned int q = 0; | // start code |
| int i, d = 0; | // start direction |

/* scan bits: */
for (i=1; i<=b; i++) {

unsigned int a_i, b_i, g_i, q_i;
/* extract bits: */
a_i = (alpha >> (b-i)) & 1;
b_i = (beta >> (b-i)) & 1;
g_i = (gamma >> (b-i)) & 1;
/* get partition index q_i: */
if (!d)

| | |
|---|---|
| q_i = a_i + 2*b_i + 3*g_i; | // \hat{ } - type triangle |

else

| | |
|---|---|
| q_i = 6 − (a_i + 2*b_i + 3*g_i) ; | // v - type triangle |

/* detect change in direction: */
if (!q_i)

d \hat{ }= 1;

/* save q_i: */
q |= q_i << ((b-i)*2);

}
return q;

}
/*
* test program & demo:
* quantizes and encodes parameters of a mixture:
* Y = 0.299 R + 0.587 G + 0.114 B;
* (RGB−>luminance conversion)
*/
int main(int argc, char*argv[ ])
{

| /* set precision: */ | |
|---|---|
| int b = 10; | |
| /* define factors: */ | |
| unsigned int alpha | = (int)floor(0.299 * ((1<<b)−1) + 0.5); |
| unsigned int beta | = (int)floor(0.587 * ((1<<b)−1) + 0.5); |
| unsigned int gamma | = (int)floor(0.114 * ((1<<b)−1) + 0.5); |

unsigned int i, q; unsigned char *Q = “DABC”;
/* enforce unit sum: */
if (alpha + beta + gamma != (1<<b)−1))

gamma = ((1<<b)−1) − alpha − beta;

/* compute partition code: */
q = q_code (alpha, beta, gamma, b);
/* print results: */
printf (“Converting tripple:\n”);
printf (“ alpha=”);
for (i=1; i<=b; i++) printf (“%d”, (alpha>>(b-i)) & 1);
printf(“\n”);
printf (“ beta =”);
for (i=1; i<=b; i++) printf (“%d”, (beta >>(b-i)) & 1);
printf(“\n”);
printf (“ gamma=”);
for (i=1; i<=b; i++) printf(“%d”, (gamma>>(b-i)) & 1);
printf(“\n”);
printf (“into:\n”);
printf (“ Q=”);
for (i=1; i<=b; i++) printf(“%c”, Q[(q>>((b-i) *2)) & 3]);
printf(“\n”);
return q;

}

The above function referred to as “main” sets the value for the alpha, beta and gamma parameters such that value for each of the alpha, beta and gamma parameters have a precision of 10 bits. The main function then executes the q_code function set forth above the main function, which encodes the values for these three parameters using equation (4) and (5) above. In particular, the q_code function first determines the most significant bit of each of the parameter values and then applies equation (4) to determine the one of the portions that includes the point defined by the parameter values. If the result of equation (4) is zero (indicates that the middle Delta region contains the point), the q_code function sets the Boolean switch described above to trigger equation (5) for the next iteration. The q_code function continues in this iterative manner to traverse the next most significant bit until reaching the least significant bit.

Parameter coding unit 85 may include hardware that executes the above code to implement the techniques described in this disclosure. Parameter coding unit 85 may determine 10-bit parameter values in accordance with the above code as follows:

alpha=0100110010
beta =1001011001
gamma=0001110100.

Parameter coding unit 85 may then output in accordance with the above code the encoded parameters as the following sequential representation of symbols:

### Q=BADABDBCAB,

where each symbol is two-bits for a total of 20 bits in the sequential representation.

Notably, the number of bits used by the sequential representation may be the same as one used by binary transmission of only a subset of the parameters, e.g., only two of the three parameters, but result in an accuracy that is possibly much higher than the subset encoding. As shown below, the accuracy may be twice as much as that of the subset encoding conventional process.

Typically, accuracy is measured in terms of a mathematical norm and, more specifically, an infinite or maximum norm. Notably, the parameter coding techniques may provide inherently for quantization in that truncation of the sequential representation Q may round or otherwise approximate the parameters. Considering Q after some recursive iteration k, Q becomes:
Q^{[k]}=q₁ q₂ q₃ . . . q_{k . . .}
   Q^{[k]} may represent a point in the middle of the last triangle defined by the above sequence of partitions and, as a result, Q^{[k]} can be viewed as an approximation of Q.

Considering further that α, α^{[k]} represent α-coordinates of points Q and Q^{[k]}, respectively, β, β^{[k]} represent β-coordinates of points Q and Q^{[k]} respectively, and γ, γ^{[k]} represent γ-coordinates of points Q and Q^{[k]}, respectively. Under these assumptions, L_{∞} norm for Q and Q^{[k]} may defined in accordance with the following equation (4):

$${‖ Q - {Q}^{[ k ]} ‖}_{∞} = max \{ \vert α - {α}^{[ k ]} \vert , \vert β - {β}^{[ k ]} \vert , \vert γ - {γ}^{[ k ]} \vert \} \leq \frac{1}{3} {2}^{- k} \qquad ( 4 )$$

Considering further the L₂ distance between all three parameters, the L₂ norm may be represented as the following equation (5):

$${‖ Q - {Q}^{[ k ]} ‖}_{2} \leq \frac{\sqrt{5}}{3} {2}^{- k} . \qquad ( 5 )$$

Equation (5) follows from the fact that the radius of a circumscribed circle for an equilateral triangle, such as that shown in FIGS. 7A-7C, with size a is R=\sqrt{3}/3 a and a for the triangle shown in FIGS. 7A-7C has a side of \sqrt{2}, which is then halved at each iteration. In this respect, truncation of the sequential representation Q provides a simple and effective tool for quantization of parameters. In fact, this quantization may be optimal in terms of a L_{∞} norm.

In order to achieve an optimal result for in terms of L₂ norm (e.g., under fine-grain granularity conditions), parameter coding unit 85 may further overlay a hexagonal lattice to further improve the L₂ norm from the norm expressed by equation (5) to the norm expressed by equation (4). The triangular partitions enable parameter coding unit 85 to derive coordinates of hexabonal cells and the centroids of these cells.

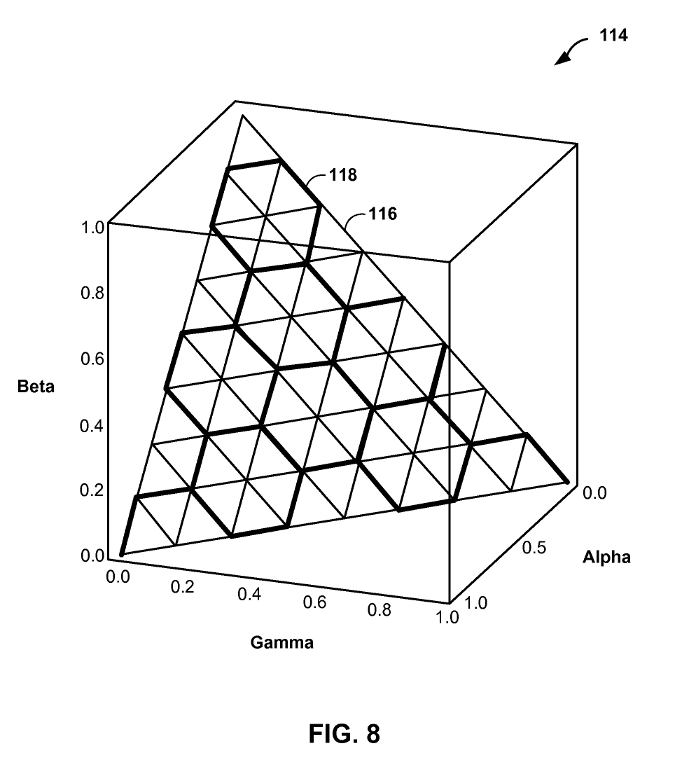

FIG. 8 is a diagram illustrating an exemplary graph 114 depicting a quantization scheme utilizing the parameter coding techniques described in this disclosure. Parameter coding unit 85 may determine the geometry of and segment space 116 in the manner described above. Parameter coding unit 85 may then overlay hexagonal lattice 118 over segmented space 116, determine one of the portions resulting from the segmentation includes the point and encode that portion with respect to hexagonal lattice 118. In this manner, parameter coding unit 85 may augment the inherent quantization to further improve the L₂ norm, as described above.

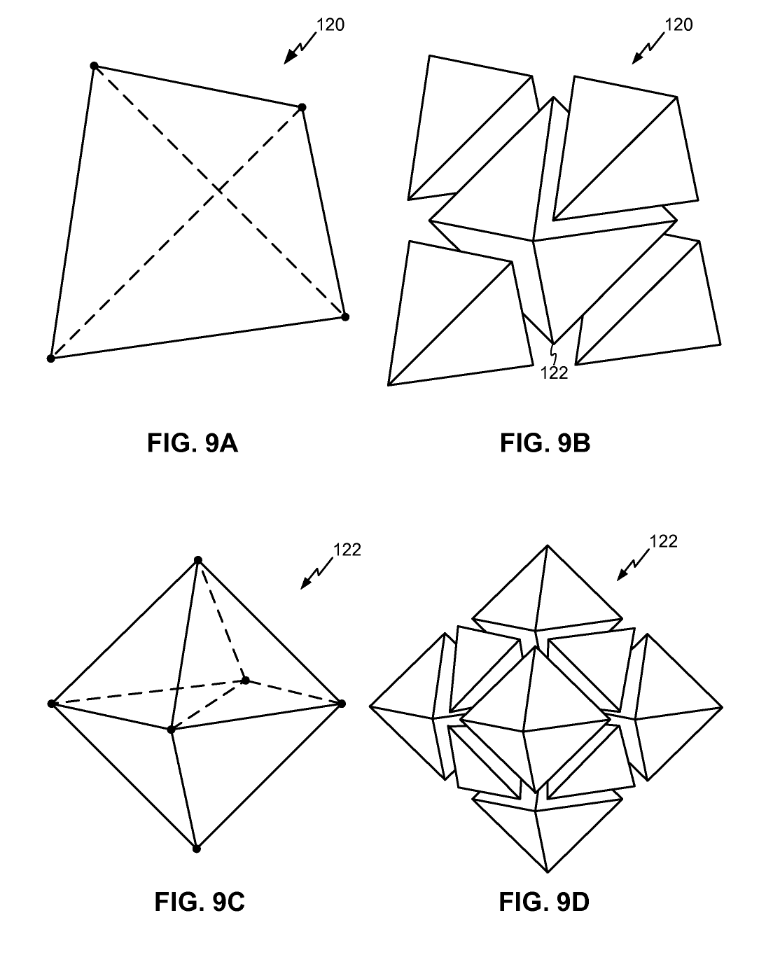

FIGS. 9A-9D are diagrams illustrating a higher order parameter space 120 being partitioned in accordance with the parameter coding techniques described in this disclosure. space 120 may comprise a 3-simplex that defines a space comprising all values of a four parameter mixture, alpha, beta, gamma and delta (δ). FIG. 9A is a diagram illustrating a geometry of space 120 determined by ₐ parameter coding unit, such as parameter coding unit 85 of FIG. 5. Parameter coding unit 85 may determine space 120 when, for example, another color is to be represented and driven for a set duration of time. Typically, this other color is, in fact, the absence of color, e.g., the color black. Source controller 84 may implement the color block by not driving any of color source units 78.

Parameter coding unit 85 may, in a first iteration of the parameter coding techniques described above segment space 120 into the portions shown with respect to FIG. 9B. FIG. 9B is a diagram illustrating a resulting space 120 after a first iteration of the parameter coding techniques described in this disclosure. Parameter coding unit 85 may segment space 120, which was a tetrahedron, into four tetrahedron portions and an octahedron portion 122. FIG. 9C is a diagram illustrating the octahedron portion 122 of FIG. 9B in more detail. Assuming parameter coding unit 85 selects this octahedron portion and segments this octahedron portion, the result of this segmentation is shown with respect to FIG. 9D. FIG. 9D is a diagram illustrating the result of the second iteration segmentation of the octahedron resulting from the first iteration segmentation of space 120 of FIG. 9A.

Generally, FIGS. 9A, 9B illustrate segmentation of a tetrahedron component in accordance with the techniques of the disclosure that results in four tetrahedron portions and one octahedron portion. FIGS. 9C, 9D illustrate segmentation of an octahedron portion 122 in accordance with the techniques of the disclosure that results in eight tetrahedron portions and six octahedron portions (that correspond to corners of the original octahedron space). Parameter coding unit 85 may then select any of these portions and proceed recursively using one of the above two methods to further segment the resulting portions. The mapping of sequential representations in this case may have two modalities that alternate between alphabets of sizes five (for segmenting tetrahedron portions) and 14 (when segmenting octahedron portions).

Thus, while described with respect to 2-simplex spaces, the techniques may be applied to higher order spaces, such as the above 3-simplex space. However, the techniques may apply to even higher order spaces, as higher dimension simplices are conceptually generalizations of tetrahedron to n-dimensions. For example, a 4-simplex fills a space between five fully interconnected vertices in four dimensions (e.g., a so-called pentatop body). Generally, an n-dimensional simplex has n+1 vertices, (₂ⁿ) edges, and (ₖ₋₁ⁿ⁻¹) k-faces. In each instance, the above techniques described with respect to 3-simplices may be generalized to higher dimensional simplices.

While described above with respect to coding stochastic sources and facilitate display of 3-dimension (e.g., red, green and blue) and n or higher state (e.g., red, green, blue and black) temporal modulation, the techniques may also be implemented with respect to any other application that utilizes parameters having unit sum so as to facilitate more accurate encoding of these parameters. For example, human visual perception is bounded by 3-dimensions in that visual perception is essentially a mixture of responses from three types of photoreceptor cells (e.g., so-called long or L-type, medium or M-type and short or S-type cone cells) in the human retina. Moreover, from the perspective of human perception, it is often preferential to separate overall brightness (or luminance) from other characteristics.

To reproduce this aspect of the human visual system with a computing device, the computing device may map color in XYZ space (where luminance surfaces as a Y-coordinate) and then apply the following transformations:

$$x = \frac{X}{X + Y + Z} ; y = \frac{Y}{X + Y + Z} ; z = \frac{Z}{X + Y + Z} ;$$

which produce so-called color chromaticity coordinates x, y and z. Notably, x, y and z are greater than or equal to zero and sum to one. Hence, x, y and z may represent parameters with unit sum for which the above techniques described with respect to 2-simplex may be applied. The CIE 1931 chromaticity diagram may be understood as a projection of the surface of this simplex into (x, y) axes, where of first note is that all realizable colors are bounded by a horseshoe-shaped curve (color locus). Secondly, a large (and practically sufficient) part of the locus-bounded area can be covered by mixing 3 reference colors placed at (or near to) top green and bottom red and blue colors of the locus.

With respect to this second notable aspect, the RGB color system may be defined such that any color Q is understood as a mixture of Q=rR+gG+bB; r, g, bε[0,1], where its projection to (x, y, z) chromaticity simplex produces a triangle Q_{xyz}=ρR_{xyz}+γG_{xyz}+βB_{xyz} with normalized parameters ρ, γ, βε[0,1]; ρ+γ+β=1. As already mentioned, this triangle is just a subset of the (x, y, z) simplex and the techniques described herein with respect to quantization and enumeration of 2-simplex spaces may apply to various aspects of working with this type of color representation.

While discussed herein with respect to quantization and coding these parameters so as to enable reproduction of content, the coded parameters, which may represent a sequential representation of symbols or Q, may facilitate other operations or application as well. For example, a set of points Q₁, . . . , Qₘ may each define a sequence of symbols from a quaternary alphabet, A, B, Γ, and Δ. Given this sequential representation of each of these set of points, various data structures may enable searching and sorting of these types of points. In particular, any of a tree, trie, and hash-table data structure and any other similar data structure may facilitate searching and sorting of alphanumeric sequences.

As an example, a four-way trie structure may provide for efficient storage and retrieval of the set of points Q₁, . . . , Qₘ, such that if m sequences are inserted (assuming m is large), then the average number of lookups required to find any of the sequences in the trie is about O(log m). More advanced tries, referred to as LC tries, may also facilitate any faster lookups on the order of O(log log m). Sorting using tries typically involves walking from left to right long the leaves of the trie and saving the respective leaf data in the order they appear in walk. Other types of queries such as nearest match and range searches may also be enabled using trie structures over sequential representation of simplex parameters. Adaptations may be required to differentiate between upward and downward oriented triangles and adding some sort of discriminator to the structure should be sufficient to denote which partitions are associated with switched directions of inequalities. In any event, the techniques may include various applications outside of content reproduction and may involve searching, sorting, and matching on various encoded parameters using any data structure typically utilized for searching, sorting, and matching of alphanumeric sequences.

The techniques described herein may be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. If implemented in software, the techniques may be realized at least in part by a computer-readable medium comprising instructions that, when executed, cause a processor to perform one or more of the methods described above.

A non-transitory computer-readable storage medium may form part of a computer program product, which may include packaging materials. A computer-readable medium may comprise a computer data storage medium such as random access memory (RAM), synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code or instructions may be executed by one or more processors, such as one or more DSPs, general purpose microprocessors, ASICs, field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules. The disclosure also contemplates any of a variety of integrated circuit devices that include circuitry to implement one or more of the techniques described in this disclosure. Such circuitry may be provided in a single integrated circuit chip or in multiple, interoperable integrated circuit chips in a so-called chipset. Such integrated circuit devices may be used in a variety of applications, some of which may include use in wireless communication devices, such as mobile telephone handsets.

Various examples of the disclosure have been described. These and other examples are within the scope of the following claims.

1. A method comprising:
segmenting, with an apparatus, a space that contains a plurality of parameters into a set of portions, wherein the plurality of parameters sum to a constant sum;
assigning, with the apparatus, a different one of a plurality of codewords to each of the portions;
selecting, with the apparatus, one of the set of portions that contains a point defined by the plurality of parameters; and
coding, with the apparatus, the plurality of parameters using one of the plurality of codewords assigned to the selected one of the plurality of portions.

2. The method of claim 1, wherein segmenting the space comprises recursively segmenting the space such that the selected one of the portions is further segmented for a predetermined number of iterations into additional sets of portions.

3. The method of claim 1, wherein the space comprises a simplex of an order equal to a number of the parameters minus one having a number of vertices equal to the number of the parameters.

4. The method of claim 3,
wherein the number of the plurality of parameters equals three,
wherein the simplex comprises a two-simplex (2-simplex) of an order equal to two having three vertices,
wherein segmenting the space comprises segmenting the 2-simplex into four equally-sized portions,
wherein assigning a different one of a plurality of codewords comprises assigning a different one of four codewords to each of the four equally-sized portions,
wherein selecting one of the portions comprises selecting one of the four equally-sized portions that contains the point, and
wherein coding the parameters comprises coding the parameters using one of the four codewords assigned to the selected one of the four equally-sized portions.

5. The method of claim 4,
wherein the 2-simplex is geometrically represented as an upward oriented equilateral triangle within a plane of a three dimensional coordinate system defined by the three parameters, and
wherein segmenting the 2-simplex comprises segmenting the 2-simplex into four equally sized equilateral triangle portions, wherein three of the four equilateral triangle portions are upwards oriented and one of the four equilateral triangle portions is downward oriented.

6. The method of claim 5, further comprising:
selecting the one of the four equilateral triangle portions that is downward oriented in a first iteration;
setting the space to the selected downward oriented one of the four equilateral triangle portions; and
segmenting, during a second iteration, the selected downward oriented one of the four equilateral triangle portions into four second iteration equilateral triangle portions, wherein three of the four second iteration equilateral triangle portions are downward oriented and one of the four second iteration equilateral triangle portions is upward oriented.

7. The method of claim 4, wherein selecting one of the four equally-sized portions that contains the point comprises:
parsing a bit from each of the three parameters;
determining an orientation of the 2-simplex; and
selecting, based on the determined orientation of the space, one of the four equally sized portions that contains the point based on the bit parsed from each of the three parameters.

8. The method of claim 7,
wherein determining an orientation comprises determining that the space is oriented upward, and
wherein selecting one of the four equally sized portions comprises selecting one of the four equally sized portions for the determined upward orientation in accordance with the following equation:
qᵢ=αᵢ+2βᵢ+3γᵢ
where qᵢ indicates the codeword assigned for an ith bit of the parameters, αᵢ denotes an ith bit of a first one of the three parameters, βᵢ denotes an ith bit of a second one of the three parameters, and γᵢ denotes an ith bit of a third one of the three parameters.

9. The method of claim 7,
wherein determining an orientation comprises determining that the space is oriented downward, and
wherein selecting one of the four equally sized portions comprises selecting one of the four equally sized portions for the determined downward orientation in accordance with the following equation:
qᵢ=6−(αᵢ+2βᵢ+3γᵢ)
where qᵢ indicates the codeword assigned for an ith bit of the parameters, αᵢ denotes an ith bit of a first one of the three parameters, βᵢ denotes an ith bit of a second one of the three parameters, and γᵢ denotes an ith bit of a third one of the three parameters.

10. The method of claim 1, further comprising:
receiving three or more color values that define a composite color for a portion of an image;
determining the plurality of parameters based on the color values, wherein each of the parameters indicate a time during which to display a corresponding one of three or more colors using a display device that sequentially activates each of the three or more colors based on the coded three or more color values.

11. The method of claim 1,
wherein segmenting a space comprises segmenting the space with an encoder,
wherein selecting one of the set of portions includes selecting one of the set of portions with the encoder, and
wherein coding the plurality of parameters comprises coding the plurality of parameters with the encoder.

12. The method of claim 11,
wherein the encoder comprises a video encoder, and
wherein the plurality of parameters includes one of a plurality of transform coefficients and a plurality of quantized transform coefficients.

13. The method of claim 11,
wherein the encoder comprises an audio encoder, and
wherein the plurality of parameters includes filter coefficients.

14. An apparatus comprising:
a control unit that determines a plurality of parameters,
wherein the control unit includes a parameter coding unit that that segments a space that contains the plurality of parameters into a set of portions, wherein the plurality of parameters sum to a constant sum, assigns a different one of a plurality of codewords to each of the portions, selects one of the set of portions that contains a point defined by the plurality of parameters, and codes the plurality of parameters using one of the plurality of codewords assigned to the selected one of the plurality of portions.

15. The apparatus of claim 14, wherein the parameter coding unit recursively segments the space such that the selected one of the portions is further segmented for a predetermined number of iterations into additional sets of portions.

16. The apparatus of claim 14, wherein the space comprises a simplex of an order equal to a number of the parameters minus one having a number of vertices equal to the number of the parameters.

17. The apparatus of claim 16,
wherein the number of the plurality of parameters equals three,
wherein the simplex comprises a two-simplex (2-simplex) of an order equal to two having three vertices,
wherein the parameter coding unit segments the 2-simplex into four equally-sized portions, assigns a different one of four codewords to each of the four equally-sized portions, selects one of the four equally-sized portions that contains the point, and codes the parameters using one of the four codewords assigned to the selected one of the four equally-sized portions.

18. The apparatus of claim 17,
wherein the 2-simplex is geometrically represented as an upward oriented equilateral triangle within a plane of a three dimensional coordinate system defined by the three parameters, and
wherein the parameter coding unit segments the 2-simplex into four equally sized equilateral triangle portions, wherein three of the four equilateral triangle portions are upwards oriented and one of the four equilateral triangle portions is downward oriented.

19. The apparatus of claim 18, wherein the parameter coding unit selects the one of the four equilateral triangle portions that is downward oriented in a first iteration, sets the space to the selected downward oriented one of the four equilateral triangle portions, and segments, during a second iteration, the selected downward oriented one of the four equilateral triangle portions into four second iteration equilateral triangle portions, wherein three of the four second iteration equilateral triangle portions are downward oriented and one of the four second iteration equilateral triangle portions is upward oriented.

20. The apparatus of claim 17, wherein the parameter coding unit further parses a bit from each of the three parameters, determines an orientation of the 2-simplex and selects, based on the determined orientation of the space, one of the four equally sized portions that contains the point based on the bit parsed from each of the three parameters.

21. The apparatus of claim 20, wherein the parameter coding unit determines that the space is oriented upward and selects one of the four equally sized portions for the determined upward orientation in accordance with the following equation:
qᵢ=αᵢ+2βᵢ+3γᵢ
where qᵢ indicates the codeword assigned for an ith bit of the parameters, αᵢ denotes an ith bit of a first one of the three parameters, βᵢ denotes an ith bit of a second one of the three parameters, and γᵢ denotes an ith bit of a third one of the three parameters.

22. The apparatus of claim 20, wherein the parameter coding unit determines that the space is oriented downward and wherein selects one of the four equally sized portions comprises selecting one of the four equally sized portions for the determined downward orientation in accordance with the following equation:
qᵢ=6−(αᵢ+2βᵢ+3γᵢ)
where qᵢ indicates the codeword assigned for an ith bit of the parameters, αᵢ denotes an ith bit of a first one of the three parameters, βᵢ denotes an ith bit of a second one of the three parameters, and γᵢ denotes an ith bit of a third one of the three parameters.

23. The apparatus of claim 14,
wherein the control unit receives three or more color values that define a composite color for a portion of an image and
wherein the control unit includes a parameter conversion unit that determines the plurality of parameters based on the color values, wherein each of the parameters indicate a time during which to display a corresponding one of three or more colors using a display device that sequentially activates each of the three or more colors based on the coded three or more color values.

24. The apparatus of claim 14, wherein the parameter coding unit resides within an encoder.

25. The apparatus of claim 24,
wherein the encoder comprises a video encoder, and
wherein the plurality of parameters includes one of a plurality of transform coefficients and a plurality of quantized transform coefficients.

26. The apparatus of claim 24,
wherein the encoder comprises an audio encoder, and
wherein the plurality of parameters includes filter coefficients.

27. An apparatus comprising:
means for segmenting a space that contains a plurality of parameters into a set of portions, wherein the plurality of parameters sum to a constant sum;
means for assigning a different one of a plurality of codewords to each of the portions;
means for selecting one of the set of portions that contains a point defined by the plurality of parameters; and
means for coding the plurality of parameters using one of the plurality of codewords assigned to the selected one of the plurality of portions.

28. The apparatus of claim 27, wherein the means for segmenting the space comprises means for recursively segmenting the space such that the selected one of the portions is further segmented for a predetermined number of iterations into additional sets of portions.

29. The apparatus of claim 27, wherein the space comprises a simplex of an order equal to a number of the parameters minus one having a number of vertices equal to the number of the parameters.

30. The apparatus of claim 29,
wherein the number of the plurality of parameters equals three,
wherein the simplex comprises a two-simplex (2-simplex) of an order equal to two having three vertices,
wherein the means for segmenting the space comprises means for segmenting the 2-simplex into four equally-sized portions,
wherein the means for assigning a different one of a plurality of codewords comprises means for assigning a different one of four codewords to each of the four equally-sized portions,
wherein the means for selecting one of the portions comprises means for selecting one of the four equally-sized portions that contains the point, and
wherein the means for coding the parameters comprises means for coding the parameters using one of the four codewords assigned to the selected one of the four equally-sized portions.

31. The apparatus of claim 30,
wherein the 2-simplex is geometrically represented as an upward oriented equilateral triangle within a plane of a three dimensional coordinate system defined by the three parameters, and
wherein the means for segmenting the 2-simplex comprises means for segmenting the 2-simplex into four equally sized equilateral triangle portions, wherein three of the four equilateral triangle portions are upwards oriented and one of the four equilateral triangle portions is downward oriented.

32. The apparatus of claim 31, further comprising:
means for selecting the one of the four equilateral triangle portions that is downward oriented in a first iteration;
means for setting the space to the selected downward oriented one of the four equilateral triangle portions; and
means for segmenting, during a second iteration, the selected downward oriented one of the four equilateral triangle portions into four second iteration equilateral triangle portions, wherein three of the four second iteration equilateral triangle portions are downward oriented and one of the four second iteration equilateral triangle portions is upward oriented.

33. The apparatus of claim 30, wherein the means for selecting one of the four equally-sized portions that contains the point comprises:
means for parsing a bit from each of the three parameters;
means for determining an orientation of the 2-simplex; and
means for selecting, based on the determined orientation of the space, one of the four equally sized portions that contains the point based on the bit parsed from each of the three parameters.

34. The apparatus of claim 33,
wherein the means for determining an orientation comprises means for determining that the space is oriented upward, and
wherein the means for selecting one of the four equally sized portions comprises means for selecting one of the four equally sized portions for the determined upward orientation in accordance with the following equation:
qᵢ=αᵢ+2βᵢ+3γᵢ
where qᵢ indicates the codeword assigned for an ith bit of the parameters, αᵢ denotes an ith bit of a first one of the three parameters, βᵢ denotes an ith bit of a second one of the three parameters, and γᵢ denotes an ith bit of a third one of the three parameters.

35. The apparatus of claim 33,
wherein the means for determining an orientation comprises means for determining that the space is oriented downward, and
wherein the means for selecting one of the four equally sized portions comprises means for selecting one of the four equally sized portions for the determined downward orientation in accordance with the following equation:
qᵢ=6−(αᵢ+2βᵢ+3γᵢ)
where qᵢ indicates the codeword assigned for an ith bit of the parameters, αᵢ denotes an ith bit of a first one of the three parameters, βᵢ denotes an ith bit of a second one of the three parameters, and γᵢ denotes an ith bit of a third one of the three parameters.

36. The apparatus of claim 27, further comprising:
means for receiving three or more color values that define a composite color for a portion of an image;
means for determining the plurality of parameters based on the color values, wherein each of the parameters indicate a time during which to display a corresponding one of three or more colors using a display device that sequentially activates each of the three or more colors based on the coded three or more color values.

37. The apparatus of claim 27,
wherein the means for segmenting a space comprises an encoder,
wherein the means for selecting one of the set of portions includes the encoder, and
wherein the means for coding the plurality of parameters comprises the encoder.

38. The apparatus of claim 37,
wherein the encoder comprises a video encoder, and
wherein the plurality of parameters includes one of a plurality of transform coefficients and a plurality of quantized transform coefficients.

39. The apparatus of claim 37,
wherein the encoder comprises an audio encoder, and
wherein the plurality of parameters includes filter coefficients.

40. A computer-readable storage medium comprising instructions for causing a programmable processor to:
segment, with an apparatus, a space that contains a plurality of parameters into a set of portions, wherein the plurality of parameters sum to a constant sum;
assign, with the apparatus, a different one of a plurality of codewords to each of the portions;
select, with the apparatus, one of the set of portions that contains a point defined by the plurality of parameters; and
code, with the apparatus, the plurality of parameters using one of the plurality of codewords assigned to the selected one of the plurality of portions.

41. The computer-readable storage medium of claim 40, wherein the instructions further cause the processor to recursively segmenting the space such that the selected one of the portions is further segmented for a predetermined number of iterations into additional sets of portions.

42. The computer-readable storage medium of claim 40, wherein the space comprises a simplex of an order equal to a number of the parameters minus one having a number of vertices equal to the number of the parameters.

43. The computer-readable storage medium of claim 42,
wherein the number of the plurality of parameters equals three,
wherein the simplex comprises a two-simplex (2-simplex) of an order equal to two having three vertices,
wherein the instructions further cause the processor to segment the 2-simplex into four equally-sized portions, assign a different one of four codewords to each of the four equally-sized portions, select one of the four equally-sized portions that contains the point, and code the parameters using one of the four codewords assigned to the selected one of the four equally-sized portions.

44. The computer-readable storage medium of claim 43,
wherein the 2-simplex is geometrically represented as an upward oriented equilateral triangle within a plane of a three dimensional coordinate system defined by the three parameters, and
wherein the instructions further cause the processor to segment the 2-simplex into four equally sized equilateral triangle portions, wherein three of the four equilateral triangle portions are upwards oriented and one of the four equilateral triangle portions is downward oriented.

45. The computer-readable storage medium of claim 44, wherein the instructions further cause the processor to:
select the one of the four equilateral triangle portions that is downward oriented in a first iteration;
set the space to the selected downward oriented one of the four equilateral triangle portions; and
segment, during a second iteration, the selected downward oriented one of the four equilateral triangle portions into four second iteration equilateral triangle portions, wherein three of the four second iteration equilateral triangle portions are downward oriented and one of the four second iteration equilateral triangle portions is upward oriented.

46. The computer-readable storage medium of claim 43, wherein the instructions further cause the processor to parse a bit from each of the three parameters, determine an orientation of the 2-simplex, and select, based on the determined orientation of the space, one of the four equally sized portions that contains the point based on the bit parsed from each of the three parameters.

47. The computer-readable storage medium of claim 46, wherein the instructions further cause the processor to determine that the space is oriented upward, and select one of the four equally sized portions for the determined upward orientation in accordance with the following equation:
qᵢ=αᵢ+2βᵢ+3γᵢ
where qᵢ indicates the codeword assigned for an ith bit of the parameters, αᵢ denotes an ith bit of a first one of the three parameters, βᵢ denotes an ith bit of a second one of the three parameters, and γᵢ denotes an ith bit of a third one of the three parameters.

48. The computer-readable storage medium of claim 46, wherein the instructions further cause the processor to determine that the space is oriented downward, and select one of the four equally sized portions for the determined downward orientation in accordance with the following equation:
qᵢ=6−(αᵢ+2βᵢ+3γᵢ)
where qᵢ indicates the codeword assigned for an ith bit of the parameters, αᵢ denotes an ith bit of a first one of the three parameters, βᵢ denotes an ith bit of a second one of the three parameters, and γᵢ denotes an ith bit of a third one of the three parameters.

49. The computer-readable storage medium of claim 40, wherein the instructions further cause the processor to:
receive three or more color values that define a composite color for a portion of an image; and
determine the plurality of parameters based on the color values, wherein each of the parameters indicate a time during which to display a corresponding one of three or more colors using a display device that sequentially activates each of the three or more colors based on the coded three or more color values.
